(19) United States
(12) Patent Application Publication
(10) Pub. No.: US 2025/0014098 A1
(43) Pub. Date: Jan. 9, 2025

(54) DEMAND AND ALLOCATION PREDICTION MODELING

(71) Applicant: PrimaryBid Limited, London (GB)

(72) Inventors: Salil Shree Pandit, London (GB); Brendan David Cheshire, Sheffield (GB); Michael Christopher Coombes, London (GB); Joseph Lyle Carnell, London (GB); Andrew James Turner, Buckinghamshire (GB); Nafiseh Vahabi, Surrey (GB); Anand Sambasivan, London (GB); Kieran Roy D’Silva, London (GB); James Alexander Deal, Winchester (GB); Gavin David Sutton, London (GB); Hanna Karpuk, London (GB); Nicholas James Osborne, London (GB); James Nicholas Sanderson Smith, Kent (GB)

(73) Assignee: PrimaryBid Limited, London (GB)

(21) Appl. No.: 18/347,071

(22) Filed: Jul. 5, 2023

(51) Int. Cl. G06Q 40/04; G06N 20/00

(52) U.S. Cl. CPC G06Q 40/04; G06N 20/00

(57) ABSTRACT

Aspects of the disclosure provide for pre-deal and in-deal or live demand and allocation forecasting. For instance, historical data including information about prior completed offers may be accessed and used to generate a plurality of training input features and a plurality of training output features. These may be used to train a pre-deal demand model configured to generate a demand prediction for a new offer based on a plurality of input features for the new offer. In addition, these may be used to train a live demand model configured to generate a demand prediction for an offer while the offer is open based on a plurality of input features for the offer. Still further, a plurality of potential allocation policies to the demand prediction to generate an allocation in real time while the offer is open.

### BACKGROUND

Various systems may offer users the ability to participate in deals involving the sale of securities such as initial public offerings (IPOs), placements (e.g., private offerings, new public share issuances, etc.), secondary offerings, fixed income products (e.g., bonds), etc. Such users may include issuers (e.g. the companies issuing securities pursuant to the deals),) and customers who are purchasing the offered securities. Such deals may be highly complex, which has made prior efforts to model and predict outcomes, which have been mostly manual efforts, particularly laborious and error prone.

### BRIEF SUMMARY

Aspects of the disclosure provide a system comprising one or more server computing devices having one or more processors. The one or more processors are configured to access historical data for prior completed offers; generate, from the historical data, a plurality of training input features and a plurality of training output features; and use the plurality of training input features and the plurality of training output features to train a pre-deal demand model configured to generate a demand prediction for a new offer based on a plurality of input features for the new offer.

In one example, the one or more processors are further configured to identify categories of the input features using a grid search algorithm. In another example, the one or more processors are further configured to identify categories of the input features using a correlation matrix. In another example, the input features include offering features, direct investor features and indirect investor features. In another example, the one or more processors are further configured to train a plurality of pre-deal demand models for different categorizations of market cap values. In another example, the one or more processors are further configured to train a plurality of pre-deal demand models for different types of offers including offers that are initial public offerings and offers that are not initial public offerings. In another example, the one or more processors are further configured to input the plurality of input features into the pre-deal demand model and generate the demand prediction. In this example, the one or more processors are further configured to select the pre-deal demand model from a plurality of pre-deal demand models based on one or more characteristics of the new offer. In another example, the one or more processors are further configured to input the demand prediction into a pre-deal allocation model to generate an allocation prediction. In another example, the allocation prediction identifies how securities are expected to be distributed across cohorts of users with certain user attributes.

A further aspect of the disclosure provides a system comprising one or more server computing devices having one or more processors. The one or more processors are configured to access historical data for prior completed offers; generate, from the historical data, a plurality of training input features and a plurality of training output features based on the historical data; and use the plurality of training input features and the plurality of training output features to train a live demand model configured to generate a demand prediction for an offer while the offer is open based on a plurality of input features for the offer.

In one example, the one or more processors are further configured to track information related to the offer in real time and to input the tracked information into the live demand model and generate the demand prediction in real time while the offer is open. In this example, the tracked information includes participation rates of cohorts of users with certain user attributes. In another example, the one or more processors are further configured to input the demand prediction into a live allocation model in order to generate an allocation prediction for a plurality of potential allocation policies in real time while the offer is open. In this example, each allocation prediction identifies how securities may be distributed across cohorts of users with certain user attributes. In addition, each allocation policy is a rule-based policy that includes one or more user attributes. In addition or alternatively, the live allocation model includes a decision tree. In another example, the demand prediction includes a prediction for demand for each of a plurality of different cohorts of users with certain user attributes. In this example, the plurality of input features is broken out by cohorts of users with certain user attributes, and the plurality of training output features are broken out by the cohorts of users with certain attributes. In another example, the one or more processors are further configured to, once the offer is closed, input a final demand for the offer into an allocation model in order to generate allocation predictions for a plurality of potential allocation policies. In this example, the one or more processors are further configured to receive user input identifying one of the plurality of potential allocation policies, and in response to receiving the user input, to automatically allocate securities.

### BRIEF DESCRIPTION OF THE DRAWINGS

FIG. 1 is a pictorial diagram of an example system in accordance with aspects of the disclosure.

FIG. 2 is a functional diagram of the system of FIG. 1 in accordance with aspects of the disclosure.

FIGS. 3A, 3B, and 3C provide example representations of bucketizing historical data for a plurality of closed deals in accordance with aspects of the disclosure.

FIG. 4 provides an example of historical data for a closed deal including missing values for a deal which previously closed in accordance with aspects of the disclosure.

FIG. 5 depicts box plots for features from historical data for a closed deal in accordance with aspects of the disclosure.

FIG. 6 depicts box plots for example features from historical data for a closed deal in accordance with aspects of the disclosure.

FIG. 7 depicts an example representation of a frequency distribution of features from historical data for a closed deal in accordance with aspects of the disclosure.

FIG. 8 depicts a distribution of user age from historical data for a closed deal in accordance with aspects of the disclosure.

FIG. 9 depicts a distribution of user age relative to demand from historical data for a closed deal in accordance with aspects of the disclosure.

FIG. 10 depicts an example representation of a normalized distribution of demand from historical data for a closed deal in accordance with aspects of the disclosure.

FIGS. 11A and 11B provide an example representation of a single correlation matrix for historical data for a closed deal in accordance with aspects of the disclosure.

FIGS. 12A and 12B provide an example representation of a single correlation matrix for historical data for a closed deal in accordance with aspects of the disclosure.

FIG. 13 represents a plot of feature importance relative to demand forecasting for historical data for a closed deal in accordance with aspects of the disclosure.

FIGS. 14A, 14B, 14C, and 14D each provide graphs of the most important features for different types of deals in accordance with aspects of the disclosure.

FIG. 15 provides an example representation of demand predictions plotted with actual demand from historical data for a plurality of deals in accordance with aspects of the disclosure.

FIG. 16 provides a feature set diagram for direct pre-deal demand models and indirect pre-deal demand models in accordance with aspects of the disclosure.

FIG. 17 provides a comparison of historical data for a plurality of closed deals from different points in time to demand predictions generated from the pre-deal demand models using the features of those closed deals in accordance with aspects of the disclosure.

FIG. 18 is an example functional representation of a demand prediction process in accordance with aspects of the disclosure.

FIG. 19 is an example functional representation of an allocation prediction and allocation policy selection process in accordance with aspects of the disclosure.

FIG. 20 is an example confusion matrix which demonstrates performance of an allocation prediction model on testing data points generated from historical data for closed deals in accordance with aspects of the disclosure.

FIGS. 21A and 21B provide example book build curves from historical data for closed deals in accordance with aspects of the disclosure.

FIG. 22 provides an example visualization of demand prediction and related information for a live deal in accordance with aspects of the disclosure.

FIG. 23 is an example representation of a summary of a resulting allocation for a given allocation policy in accordance with aspects of the disclosure.

FIG. 24 is an example visualization of resulting allocations for different allocation policies for a live deal in accordance with aspects of the disclosure.

FIG. 25 is an example flow diagram in accordance with aspects of the disclosure.

FIG. 26 is an example flow diagram in accordance with aspects of the disclosure.

### DETAILED DESCRIPTION

### Overview

The technology relates to demand and allocation prediction modeling for the processes of initial public offerings (IPOs), placements (e.g., private offerings, new public share issuances, etc.), secondary offerings, fixed income products (e.g., bonds), etc. Each offering may be broken into three main phases: pre-deal, in-deal and post-deal. In the pre-deal phase, market data, issuer (e.g. the company issuing securities pursuant to the relevant deal) data, and other data may be used to predict demand and allocations for the offer. During the in-deal phase, additional predictions about the final demand (at the time the deal closes) and allocations may be generated which forecast how securities may be distributed across cohorts of investors (users) before the deal has closed. In the post-deal phase, issuers may be provided with visualizations that compare a range of allocation policies based on the final results of the deal.

In the pre-deal phase, the issuer may identify desired attributes of users. For example, cohorts may be identified based on user attributes such as employees, customers, potential customers, and sub-categories of these.

Pre-deal demand models may be configured to provide a feature analysis corresponding to a prediction of demand as noted above. Each prediction may include a confidence interval which identifies lower and upper bounds for the prediction. The pre-deal demand models may also reveal insight into which inputs have the greatest effect on the predictions. With these predictions, an issuer may be able to simulate demand for an array of potential launch days and times, from which the models may even provide suggestions for the “best” timing to maximize demand.

The pre-deal demand models may be configured such that for a given set of input features, a demand prediction including a plurality of dynamic time-series values may be provided. Deal-specific features for each offering may be paired with a plurality of the aforementioned input features for modeling purposes. Training of the pre-deal demand models may be based on historical data. This historical data may be bucketed into different categorizations. For each offering, the historical data may be further categorized into input features and output features for training purposes.

In this regard, the system may access historical data for prior completed offers. This may then be used to generate a plurality of training input features and a plurality of training output features. The plurality of training input features and the plurality of training output features may then be used to train a pre-deal demand model configured to generate a demand prediction for a new offer based on a plurality of input features for the new offer. The pre-deal demand model may then be used to generate demand predictions.

Pre-deal allocation models may be configured to provide a feature analysis for a given prediction of demand as noted above. In other words, with a predicted demand generated for a deal, an issuer may apply a range of allocation policies to simulate their impact across user cohorts. Such allocation policies may be rules-based and may be provided by the issuer and may be specific to the particular offering. An allocation policy may employ a series of custom user attributes. As noted above, the allocation policies may be applied to the output of the pre-deal demand models.

The demand prediction, allocation policies and pre-deal allocation prediction models may then be used to provide an allocation expressed with summary analytics and which can be queried on a line-by-line basis. In other words, multiple allocation policies can be “tested” and compared by the issuer simultaneously, even before a deal is live. Each allocation prediction model may include a machine learning model, such as a decision tree including random forest, which includes both numerical and categorical attributes of users, and may be trained using the aforementioned historical data. A confusion matrix may be used to demonstrate the performance of the user allocation prediction models on testing data points.

During the in-deal phase, or when an offer is live, information related to the offer may be tracked by the system in real-time. This real-time or live information may be used to predict demand during the deal by inputting the live information as well as other information into the live demand model. The live information as well as the predicted demand may also be provided to the issuer (as well as the issuer's representatives, advisors, etc.) during the deal. As information for the offering is input into the system, it is combined with user attribute and cohort information and input into the live demand models. The live demand models may be used to provide predictions for how demand will look by cohort once the offer closes. This may allow an issuer to evaluate the impact of various allocation policies on each cohort based on the predicted final demand.

As with the pre-deal demand models, the live demand and allocation models may be trained using the aforementioned historical data as well as user cohort and user attribute features as inputs, or dynamic demand-based information. Actual final demand data may be used as training outputs. Such outputs may take the form of a predicted demand number, with a confidence interval. This confidence interval may narrow as the deal progresses and the model is better able to predict the shape of the final book. Additionally, the output may present the expected closing distribution of demand across user attributes.

As noted above, the pre-deal demand models may use many features from market data, deal's feature, first party (e.g., direct investors) and third party (e.g., indirect investors) features. However, the pre-deal demand models do not utilize live information as the deal has not yet opened. The live demand models may use the behavior of demand flow from historical data in conjunction with live information about the deal generated in real time. Again, with a final demand prediction generated for the outcome of a deal, an issuer may apply a range of allocation policies to simulate their impact across user cohorts using live allocation prediction models. The live allocation models may be used to provide an allocation expressed with summary analytics and which again can be queried on a line-by-line basis. In other words, multiple allocation policies can be “tested” and compared by the issuer simultaneously, even before a deal closes. Each live allocation model may include a machine learning model, such as a decision tree including random forest, which includes both numerical and categorical attributes of users, and may be trained using the aforementioned historical data. As with the pre-deal allocation models, a confusion matrix may be used to demonstrate the performance of the user allocation prediction models on testing data points.

Once the offer has closed, in the post-deal phase, an issuer may review the actual impact of different allocation policies against the deal (now the closed book). In some examples, when displaying the impact of different allocation policies, these may be ranked based on different goals or policies of the issuer and displayed accordingly. The issuer may specify its own allocation policy or choose an allocation policy recommended by the model. Once the issuer has decided on a policy, the system may automatically implement that policy.

The features described herein may provide for demand and allocation prediction modeling for the processes of initial public offerings (IPOs), placements (e.g., private offerings, new public share issuances, etc.), secondary offerings, fixed income products (e.g., bonds), etc. Pre-deal demand modeling can be used to recommend which cohorts of users to include in the offering and to reduce the risk of over-subscription where more applications are received from users than the total number of securities offered, and may also be used to optimize the timing of the deal and the marketing and communication strategy before and during the deal window. In the in-deal phase, the issuer may be provided with a real-time analysis of live demand by cohort, demographics, and other information. This may enable issuers to develop relationships with new users as the issuer will have more relevant information about such users including past relationships with the issuer. As noted above, allocation policies may be applied to live demand predictions in the form of allocation prediction models. This may help issuers to mitigate the risk of rushing an allocation policy after a deal closes as in typical deals, and instead gives the issuer a preview during the pre-deal and in-deal phases of a deal of the impact of different allocation policies, thereby allowing the issuer to identify preferred, fair and balanced allocation policies before the offer closes

### Example Systems

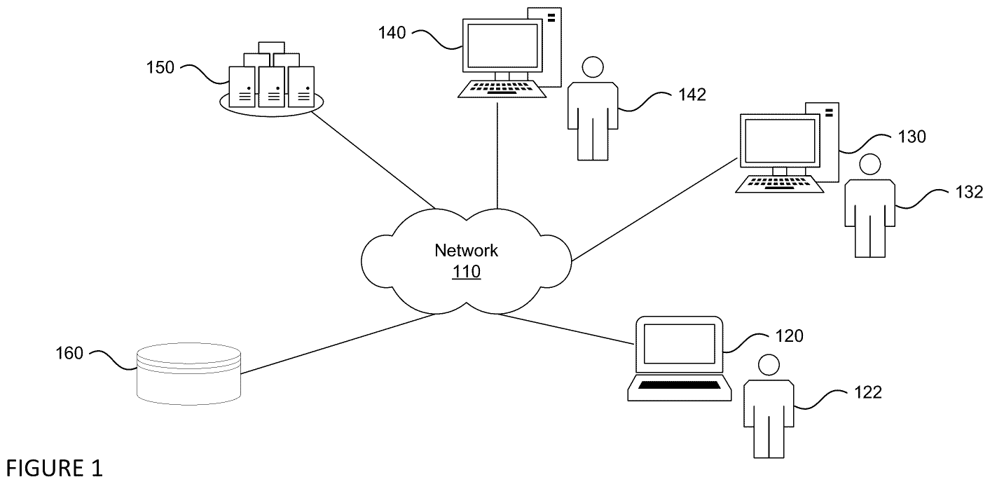

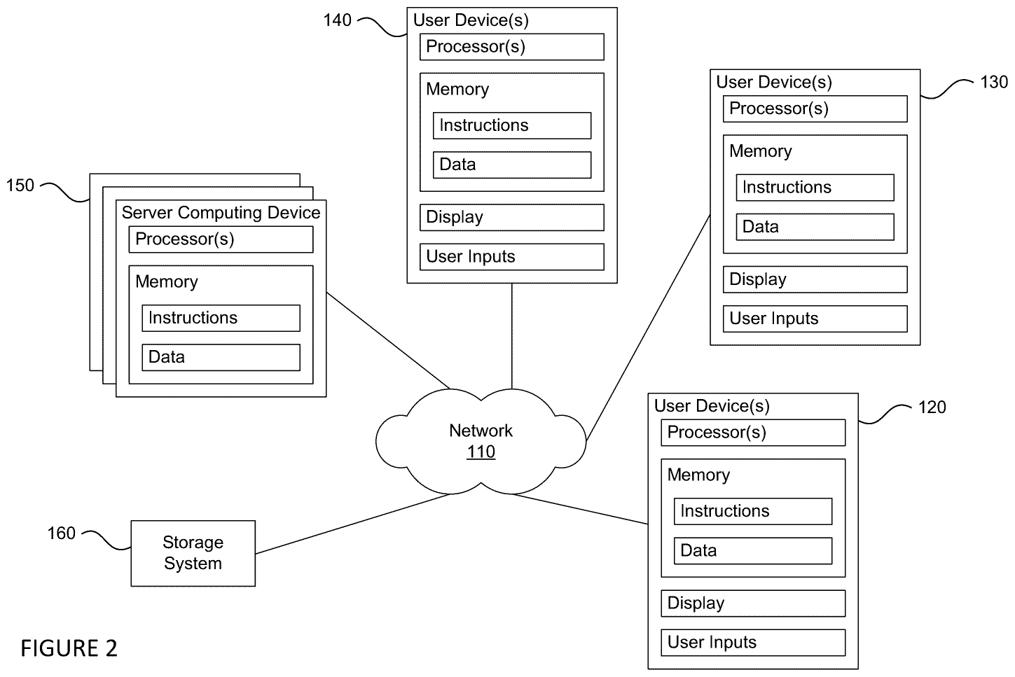

FIGS. 1 and 2 depict pictorial and functional diagrams of an example system 100 for implementing the various features described herein. As depicted, the system 100 includes a plurality of computing devices 120, 130, 140, 150 and a storage system 160 connected via a network 110. Although only a few computing devices are shown, any number of such devices may be included in the system described herein.

As shown in FIG. 2, each of the computing devices 120, 130, 140, 150 may include one or more processors, memory, data and instructions. The memory stores information accessible by the one or more processors, including instructions and data (e.g., machine translation model, parallel corpus information, feature extractors, etc.) that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing; whereby different portions of the instructions and data are stored on different types of media.

The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, etc. Alternatively, each processor may be a dedicated device such as an ASIC or other hardware-based processor. Although FIG. 2 functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server computing devices 150. Accordingly, references to a processor or computing device will be understood to include references to a collection of processors or computing devices or memories that may or may not operate in parallel.

The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users.

The computing devices 120, 130, 140 may be configured as user devices, end user devices, client computing devices, or client devices which can communicate with a back-end computing system, such as the server computing devices 150, via one or more networks, such as network 110. As an example, computing device 120 may be a laptop while computing device 130 may be a desktop computer. Such devices may be used, for instance, to provide a person (e.g. human operators or users 122, 132, 142) such as, with the ability to interact with other computing devices of the system. Other types of user devices, such as mobile phones, tablet PCs, smartwatches, head-mounted displays and other wearables, etc., may also be employed.

The network 110, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

As with the memory of the computing devices 120, 130, 140, and 150, the storage system 160 can be of any type of computerized storage capable of storing information accessible by the one or more server computing devices 150, such as a hard-drive, memory card, ROM, RAM, DVD, CD-ROM, write-capable, and read-only memories. In addition, storage system 160 may include a distributed storage system where data is stored on a plurality of different storage devices which may be physically located at the same or different geographic locations. Storage system 160 may be connected to the computing devices via the network 110 and/or may be directly connected to or incorporated into any of the computing devices 120, 130, 140, 150, etc.

Storage system 160 may store various types of information as described in more detail below. This information may be retrieved or otherwise accessed by a server computing device, such as one or more server computing devices 150, in order to perform some or all of the features described herein. For instance, the storage system may store various information (e.g., features) about prior deals (e.g., historical data) as well as a variety of models and parameter values for such models. The storage system may also be used to track a deal during each phase (e.g., pre-deal, in-deal, and post-deal).

The storage system may store pre-deal demand models and live demand models.

The storage system 160 may also store live demand models. These live demand models may be linear regression models such as Ridge, Lasso and Elastic Net models which may have different penalties to a cost function, and can handle both numerical and categorical data types in their prediction. The live demand models may be used to provide predictions for how demand will look by cohort once the offer closes (e.g., “predicted final demand”).

The storage system 160 may also store various allocation policies for various offers as well as pre-deal, in-deal and post-deal allocation prediction models. These allocation policies may be determined by issuers or generated by the system in real time as discussed further below. Each allocation prediction model may include a machine learning model, such as a decision tree including random forest, which includes both numerical and categorical attributes of users.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

In the pre-deal phase, the issuer may identify desired attributes of users. This may afford each issuer a customized experience which focuses on the most relevant users to that issuer. For example, cohorts may be identified based on user attributes such as employee, customers, potential customers, and sub-categories of these (e.g., high-activity customers, low-activity customers, customers for over 1 year, customers for under 1 year, employees for over 1 year, employees for under 1 year, and so on). Cohorts may be identified and used based on expected size relative to the total size of the offering.

Attributes of each user may be used to generate bespoke cohorts of users, (for example, all ‘gold tier’ customers, or ‘employees’). As users sign up for the offering, they may be provided with a list of questions. The system may determine, based on the answers to these questions, whether the user satisfies or does not satisfy the set of rules for each cohort. Alternatively, the users may provide information which the system may use to look up the answers to some or all such questions using third party information (e.g., a customer database of the issuer, or via a third party (for example, through an API call, single sign-on (SSO), open authentication (OAuth), etc.). If a user is not able to satisfy the set of rules for any cohort, the user may not be qualified to participate in and may be excluded from the offering. Those users who may be excluded may be provided with a flow for correcting their state (e.g., reactivate an account on the issuer platform).

The pre-deal demand models may be configured as a time-series model such as XGBoost (e.g., eXtreme Gradient Boosting). Such an approach may allow for multiple types of input features and may perform well with sparse input features for tree and linear booster approaches. In this regard, for training purposes the historical data may be analyzed to determine time-series output (or target) features as discussed further below. In some instances, a grid search algorithm may be used to optimize hyperparameters of the XGBoost and time-series model.

Other types of models may also be used. For instance, linear models (including, for example, Ridge, Lasso and ElesticNet regression models) may also be used. However, while such models may perform well with fewer numbers of input features, as the number of input features increases, the performance may be likely to decrease (e.g., error rate may increase). In other instances, support vector models, such as support vector machines or support vector regressor models including a radial basis function kernel model may be used. Such supervised learning algorithms may be particularly useful for predicting discrete outputs. In still other instances, gradient boosting models which combine multiple underlying models in order to provide better overall performance may be employed. For instance, the gradient boosting models may involve a loss function to be optimized, a decision tree models (e.g., generated using a greedy approach), and an additive model to add the decision trees together in order to minimize the loss function (e.g., using a gradient descent approach).

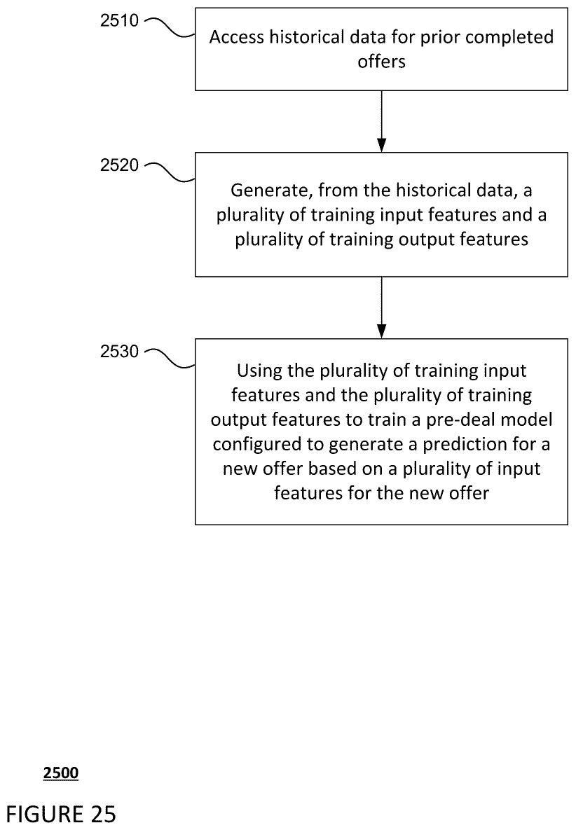

FIG. 25 is an example flow diagram 2500 for training a model, such as a pre-deal demand model or a pre-deal allocation model. At block 2510, historical data for prior completed offers is accessed. Training of the pre-deal demand models may be based on historical data. This historical data may be bucketed into different categorizations.

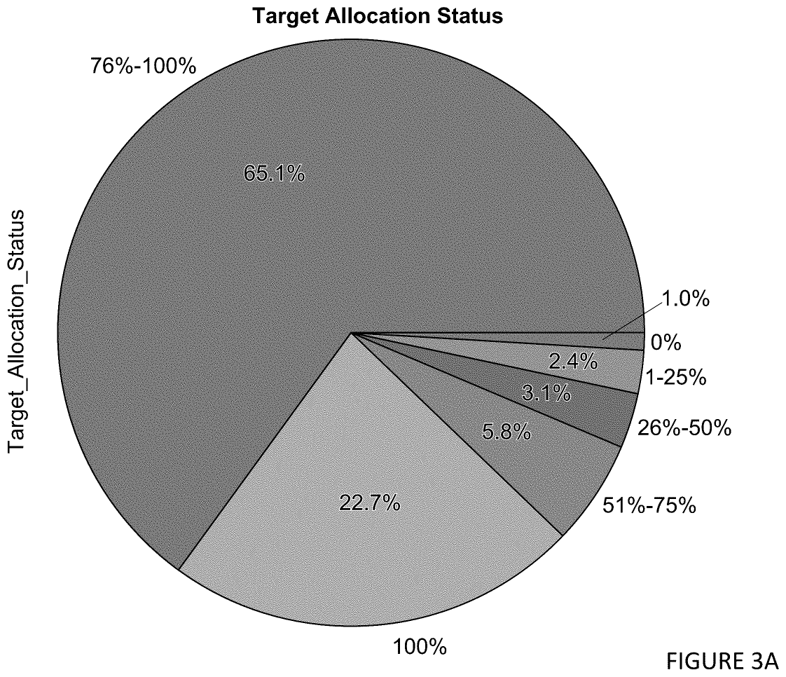

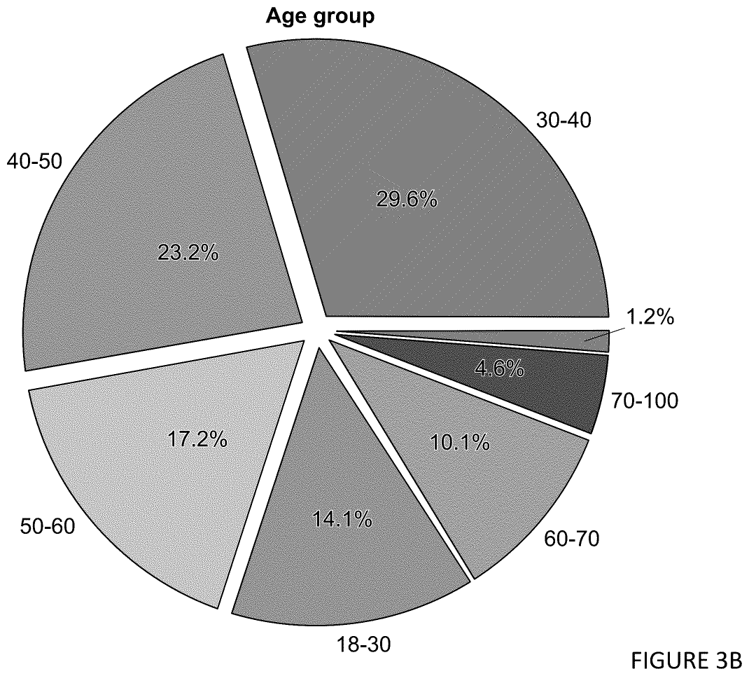

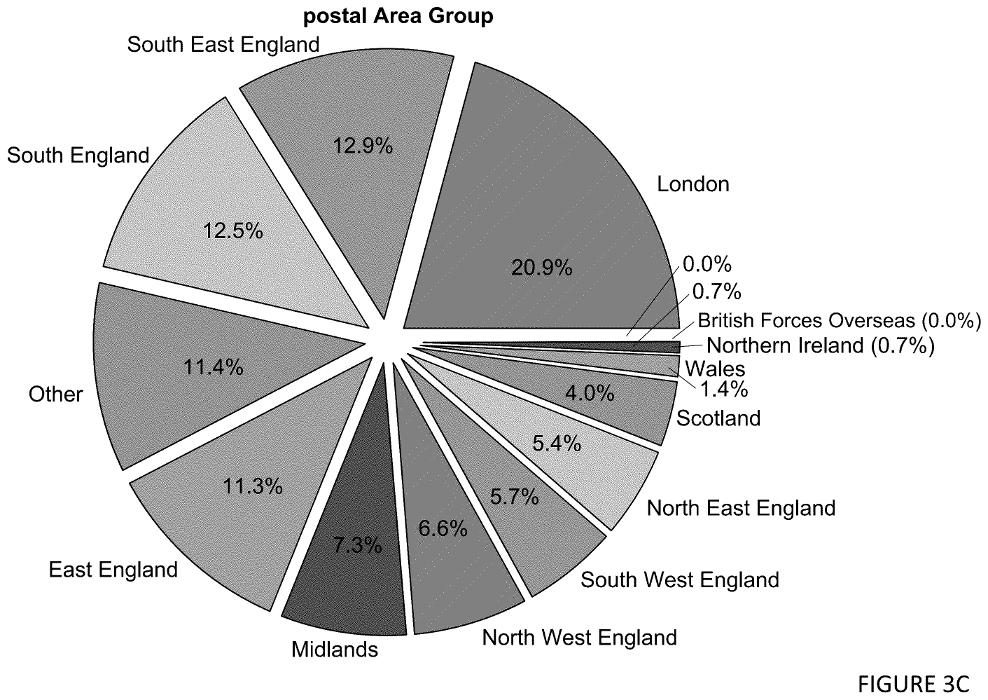

FIGS. 3A, 3B, 3C provide an example representation of bucketizing of historical data for a plurality of deals which previously closed. In the example of FIG. 3A, the historical data includes allocation rates for a plurality of deals which previously closed. In the Example of FIG. 3A, each “slice” of chart provides a percentage (written within the respective slice) of direct investors that were allocated a percentage of their subscription in one or more deals (written outside of the respective slice). In this example, the largest slice shows 65.1% of our direct investors were allocated between %76-100% when participating in the deals.

In the example of FIG. 3B, the historical data includes user ages for a plurality of deals which previously closed. The chart identifies what percentage of direct investors are in each “age bucket” or age groups. Such information may provide information as to whether certain age groups are allocated more or less in each deal. Here, 1.2% of users had unknown age, 14.1% of users had ages between 18 and 30, 29.6% of users had ages between 30 and 40, and so on.

In the example of FIG. 3C, the historical data includes user geographic location (e.g., postal area) for a plurality of deals which previously closed. The chart identifies a geographical distribution of direct investors and how investors from certain geographical locations are likely to receive allocations. Here, 1.4% of users were located in Wales, 12.5% of users were in South England, 20.9% of users were in London, and so on.

Still other types of the historical data may be processed and bucketized. For instance, each offering may have a market cap value. These may be bucketed into micro (e.g., less than 75 million dollars), small (e.g., between 75 million and 275 million dollars), mid (between 275 million dollars and 1 billion dollars), and large (e.g., greater than 1 billion dollars). Of course, different numbers of such buckets and ranges may be used. In this regard, rather than a single model, a different model may be trained and used for each categorization.

Returning to FIG. 25, at block 2520, a plurality of training input features and a plurality of training output features are generated from the historical data. For each offering, the historical data may be further categorized into training output features (e.g., target features) and training input features for training purposes or training output features and training input features, respectively. Output features for a pre-deal demand model may include demand rates for particular users (as well as the characteristics of those users), as well as features about previous deals (e.g. deal duration). Output features for a pre-deal allocation model may include allocation rates for particular users (as well as the characteristics of those users), as well as features about previous deals (e.g. deal duration).

Input features may include offering features, direct investor features (for example, user demographics, or whether the user is qualified or not qualified, or whether a user is an existing shareholder in the issuer, or dynamic attributes e.g. the number of days since the user last did a transaction, or how many total transactions they have done) and indirect investor features (for example, the partner who submits the demand, the Assets Under Management (AUM) of the partner who submits demand, or dynamic attributes such as the average demand that that indirect partner has submitted in previous deals). Each of these input features may have various different types of values including, for example, numerical, categorical, Boolean, and date. Table 1 below provides a non-exclusive listing of example input features.

TABLE 1

| Feature Name | Explanation | Feature Type |
|---|---|---|
| unique_id | Unique offer ID | Numerical |
| pb_deal_code | Unique deal ID | Numerical |
| isin | International Securities | Numerical |
| | Identification Number | |
| pb_offer_open | The date and time of | Date |
| | the deal launching | |
| pb_offer_close | The date and time of | Date |
| | the deal closing | |
| announcement_ | The date of when the | Date |
| date | deal is being announced | |
| | to the market | |
| pricing_date | The date of when the deal | Date |
| | is priced | |
| first_trade_date | The date of when the | Date |
| | security can trade on | |
| | the stock exchange | |
| | post the deal | |
| settlement_date | The date of completion/ | Date |
| | admission to trading on | |
| | the exchange of the | |
| | offered securities (e.g., | |
| | shares, bonds, etc.) | |
| company | The name of the issuer | Categorical |
| ticker | Short ticker of the issuer | Numerical |
| factset_ticker | FactSet ticker of the | Numerical |
| | issuer | |
| repeat_deals | Repeat use of the system | Boolean |
| | for offerings | |
| invst_trust | Investment trust or a | Boolean |
| | company | |
| sector_general | General sector (as per | Categorical |
| | Dealogic classification) | |
| sector_specific | Specific sector (as per | Categorical |
| | Dealogic classification) | |
| sector_gics | GICS sector (as per the | Categorical |
| | Global Industry | |
| | Classification Standard | |
| | classification) | |
| company_ | The nationality of the | Categorical |
| nationality | issuer | |
| exchange | Deal exchange (stock | Boolean |
| | exchange of the issuer) | |
| index_pb_deal | Is issuer part of the | Categorical |
| | FTSE 100 or FTSE 250 | |
| deal_type | Type of deal i.e. placing, | Categorical |
| | open offer, IPO | |
| deal_value | Total raise of the issuer | Numerical |
| | (in British pounds, dollars, | |
| | Euros, etc.) | |
| pct_primary | Percentage of the deal | Numerical |
| | where new securities are | |
| | offered | |
| selling_sh | Selling shareholder of the | Numerical |
| | stock (if a secondary deal) | |
| use_of_proceeds | Use of proceeds, the reason | Categorical |
| | for raising money | |
| pct_company_ | Percentage of the company | Numerical |
| sold | sold | |
| priceless_pb_ | At the time of launch of | Boolean |
| deal | the deal, did it launch with | |
| | a determined offer price, | |
| | if not then considered a | |
| | priceless deal | |
| pct_discount | Percentage of discount i.e. | Numerical |
| | offer price vs share price | |
| offer_price | The offer price (in a | Numerical |
| | particular currency such | |
| | as British pounds, dollars, | |
| | Euros, etc.) | |
| market_cap | Market capitalization of the | Numerical |
| | issuer (in a particular currency | |
| | such as British pounds, | |
| | dollars, Euros, etc.) | |
| 1M ADTV | Last month average daily | Numerical |
| | trading value of the company | |
| | (in a particular currency such | |
| | as British pounds, dollars, | |
| | Euros, etc.) | |
| 2M ADTV | Last 2 months average daily | Numerical |
| | trading value of the company | |
| | (in a particular currency such | |
| | as British pounds, dollars, | |
| | Euros, etc.) | |
| 3M ADTV | Last 3 months average daily | Numerical |
| | trading value of the company | |
| | (in a particular currency such | |
| | as British pounds, dollars, | |
| | Euros, etc.) | |
| 6M ADTV | Last 6 months average daily | Numerical |
| | trading value of the company | |
| | (in a particular currency such | |
| | as British pounds, dollars, | |
| | Euros, etc.) | |
| Leverage (Net | Net debt to EBITDA ratio | Numerical |
| Debt/EBITDA) | of a company | |
| VIX @announc. | VIX Index at announcement | Numerical |
| date | of the deal (US measure of | |
| | volatility) | |
| VIX @pricing | VIX Index at pricing date of | Numerical |
| date | the deal (US mesure of | |
| | volatility) | |
| V2X @announc. | V2X Index at announcement | Numerical |
| date | of the deal (European | |
| | measure of volatility) | |
| V2X @pricing | V2X Index at pricing date | Numerical |
| date | of the deal (European | |
| | measure of volatility) | |
| % Retail | Percentage of stock owned | Numerical |
| Ownership | by retail investors (based | |
| | on Factset disclosures) | |
| Retail Ownership | Value of stock owned by | Numerical |
| | retail investors (based on | |
| | Factset disclosures and in a | |
| | particular currency such as | |
| | British pounds, dollars, | |
| | Euros,etc.) | |
| pb_demand_lcy | Value raised on our deal | Numerical |
| | (demand) | |
| pb_allocated_lcy | Value allocated on our deal | Numerical |
| | (allocation) | |
| ecp_offer | Distribution of the deal via | Numerical |
| | our partners | |
| intermediaries_ | Intermediaries offer i.e. we | Numerical |
| offer | were one of the distribution | |
| | channels participating in the | |
| | deal/not running the deal | |
| employee_offer | Employee offer i.e. was the | Numerical |
| | deal specifically offered to | |
| | the issuer’s employees | |
| green_econ_ | Issuer classified as Green | Boolean |
| market | Economy Mark by the | |
| | London Stock Exchange | |
| | (indication of sustainability) | |
| Age | The age of individual investor | Numerical |
| | (specific age or bucketed age | |
| | group) | |
| Postal area | The geographical information | Categorical |
| | of the investors | |
| Is user an issuer | If the individual is an | Boolean |
| employee | employee of the issuer | |
| Qualified/non- | If the investors are qualified | Boolean |
| qualified investor | or not qualified | |
| shareholder/ | If an individual investor is a | Boolean |
| nonshareholder | shareholder of the company | |
| | raising money | |
| Asset under | Assets under management | Numerical |
| management | for each broker | |
| Advisor/Executor | If the broker is advisor, | Categorical |
| | executor or both | |
| first time user | Whether the individual has | Categorical |
| | used the system before | |
| offer_start_day | The first day offer is open | Categorical |
| offer_end_day | The last day offer is open | Categorical |
| first_subscription_ | The first day investor is | Categorical |
| day | subscribed | |
| last_subscription_ | The last day investor is | Categorical |
| day | subscribed | |
| new_customer_ | The proportion of customers | Numerical |
| mix | in a given cohort who are new | |
| | to the issuer | |
| customer_tenure | The length of time a customer | Numerical |
| | has been a customer of the | |
| | issuer | |
| lifetime_spend | The total allocated value of a | Numerical |
| | customer to the issuer over | |
| | their customer lifetime | |
| emails_in_deal | The number of emails sent | Numerical |
| | to customers in a deal | |
| push_notifications_ | The number of push | Numerical |
| in_deal | notifications sent to customers | |
| | in a deal | |
| demand_hour_x_ | The total demand submitted in | Numerical |
| perc | the period X of the deal | |
| | (various combinations) | |
| demand_vs_ | The ratio of demand in a | Numerical |
| previous_period_x | given period relative to | |
| | another period in the deal | |
| periods_into_deal | For a given period length | Numerical |
| | (e.g. minutes), the number of | |
| | those periods that have | |
| | currently passed during the | |
| | live deal | |

An example set of training input features may include, for example, a total deal value (which may correspond to the percentage of market cap being offered during the deal), the value percentage of the company to be sold, a percentage discount, market cap, or a predicted deal value from another source (e.g. from another internal model, from the issuer, or from a third party model), whether or not there is an initial price for the offering, average daily trading volume (e.g., 1 month, 2 months, 3 months, 6 months), a previous private valuation amount (in the case of an DPO), green economy market classification, sector, volatility at announce date (e.g., VIX value), volatility at pricing date, retail ownership (actual and by percentage), repeat deal (e.g., DPO vs subsequent offering through the system), deal live hour (which may represent a proposed length of the deal in hours), investment trust or company, exchange where the IPO is to be listed, Financial Times Stock Exchange (FTSE) status (if not an IPO), retail ownership, etc.

Fewer or additional training input features may also be used. For instance, new features may be generated based on the historical data. For example ‘deal-live-time’ may be generated by subtracting the end date and time of an offering from the start date and time of the offering, or market attributes such as ‘volume of deals in the market in the 30 days before the proposed launch date’ may be calculated. Features can also be constructed by using business logic such as ‘Is deal launch at 4:35 pm’. Timing may be important in a transaction as users must be able to view the offer and consider participating on the same day and sometimes within only a few hours after launching. Additionally, the feature set may be augmented by internal variables based on previous deals, for example, demand from repeat users from the most recent 5 deals, or the average retail demand submitted for the sector that a deal is in. Furthermore, the marketing plan proposed for a deal may be used as inputs into the demand model, for example, the number of emails or notifications that are planned to be sent. Conversely, the models may provide suggestions as to the “optimal” marketing strategy (e.g. the timing, channels, content of communications) to advertise the deal, to maximize demand within a planned marketing budget.

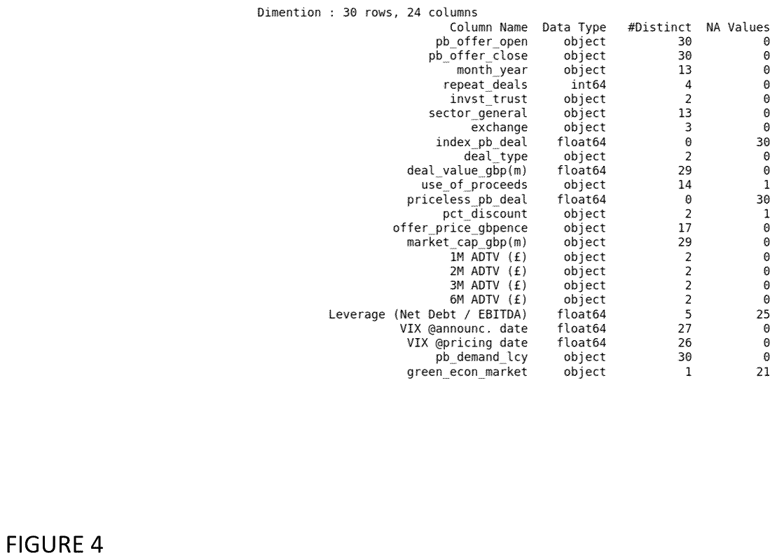

In many instances, input features for a particular offering may be missing or incorrect. In this regard, certain features which do not have values or outliers may be discarded and not used for training purposes. For example, FIG. 4 provides an example of historical data including missing values for a deal which previously closed. In this example, missing values are identified in the “NA Value” column. In this example, the first column identifies the feature name (Column Name). The second column identifies the type of data (Data Type), where ‘Object’ refers to categorical data and ‘float 64’ refers to numerical data. The third column shows how many distinct values are in each features. For example, ‘invest trust’ has 2 distinct values because it is either “Investment trust” or “Company”. The Forth column shows the number of missing values for each feature. For example, “index_pb_deal” has 30 missing values or ‘Leverage’ has 25 missing values. Accordingly, in this example, the features “index_pb_deal” and/or ‘Leverage’ may not be used to train the pre-deal model as they have so many missing values.

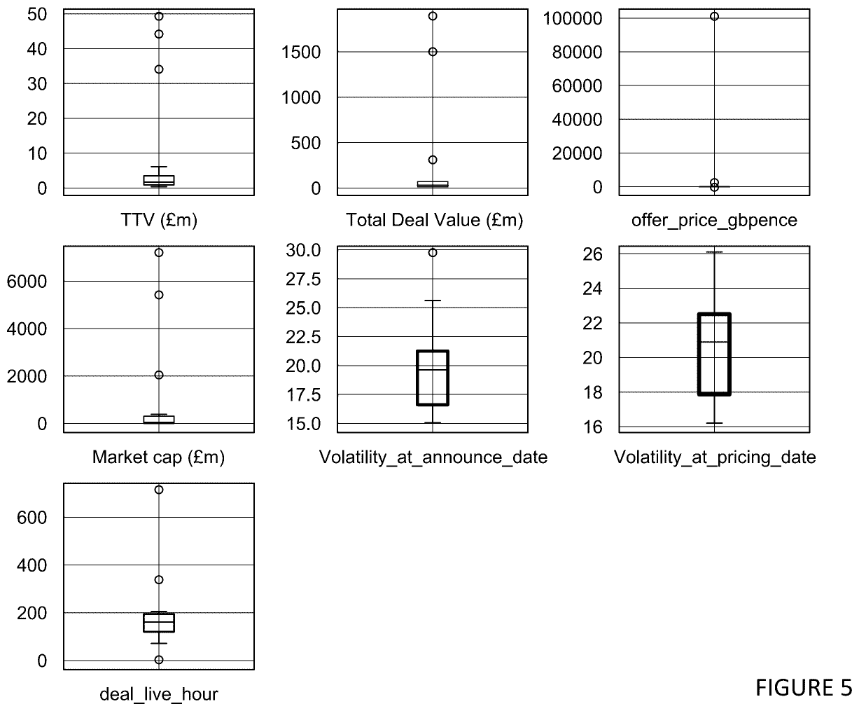

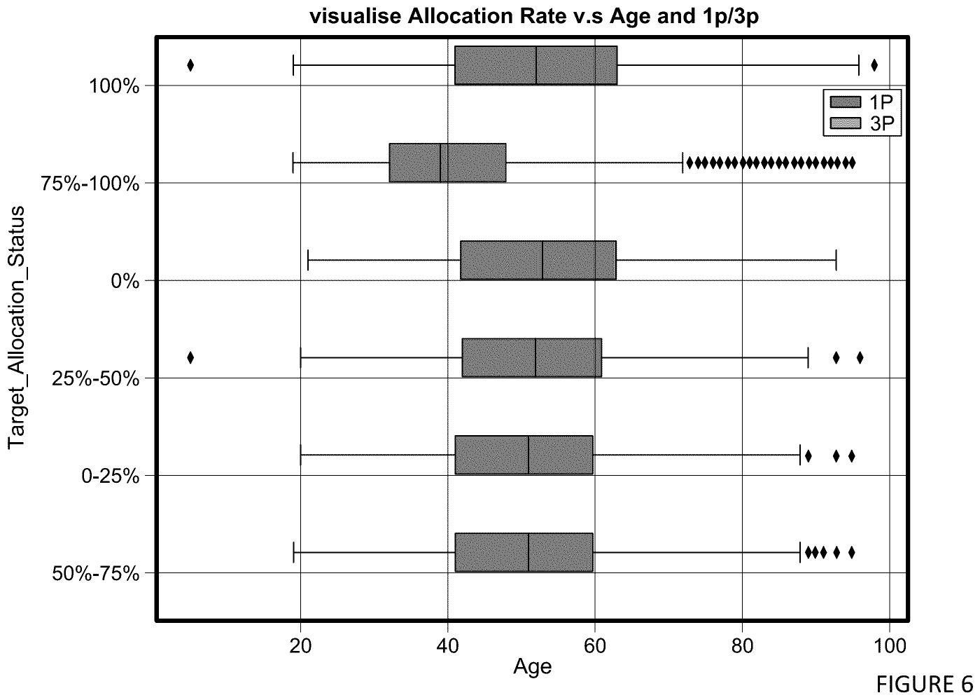

In some instances, box plots may be used to identify incorrect historical data or “outliers”. FIGS. 5 and 6 depict box plots for example features from historical data for a closed deal. FIG. 6 depicts a box plot of allocation rate by user age and direct investor (first party or 1p) and indirect investor (third party or 3p) features. As can be seen, by using box plots, outlier data can be readily identified and removed from the historical data and/or the training data.

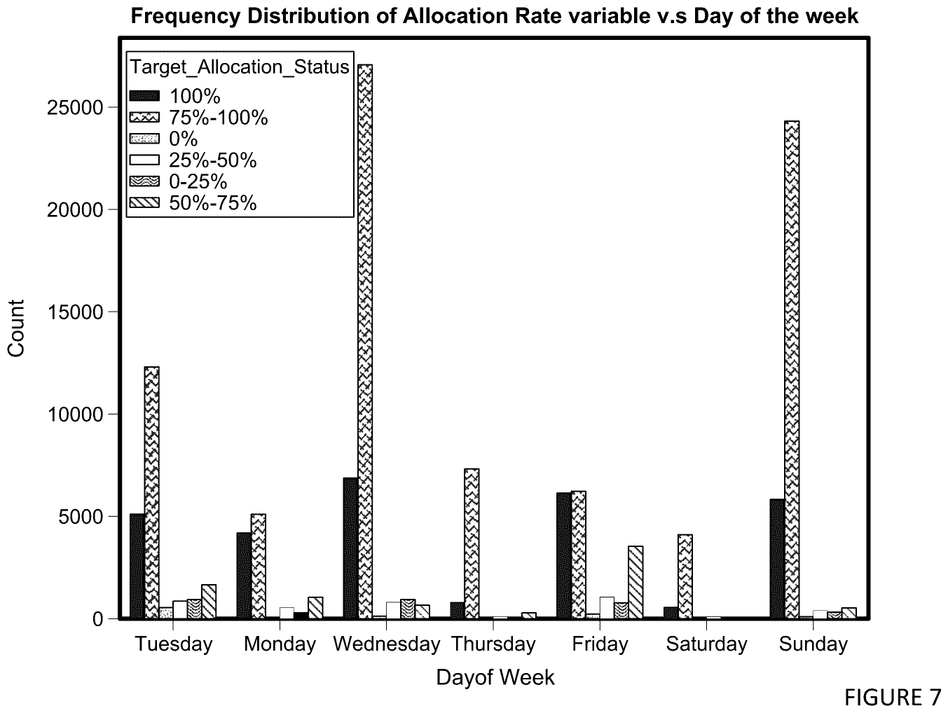

Thereafter, the remaining features may be normalized to numeric certain values (e.g., to be within a range or to correspond to a Boolean value or categorization), imputing missing values, clipping outliers and adjusting some skewed values. FIG. 7 depicts an example representation of a frequency distribution of features from historical data for closed deals. Here, the x-axis corresponds to demand value and the y-axis corresponds to the number of deals (offers). In particular, FIG. 7 depicts a frequency distribution of allocation rate relative to a day of the week from the feature pb_offer_open defined in Table 1 above. As can be seen, the historical data for closed deals may be skewed. In this example, allocation rate may be normalized to account for variation between the different days of the week, before being used to train the model.

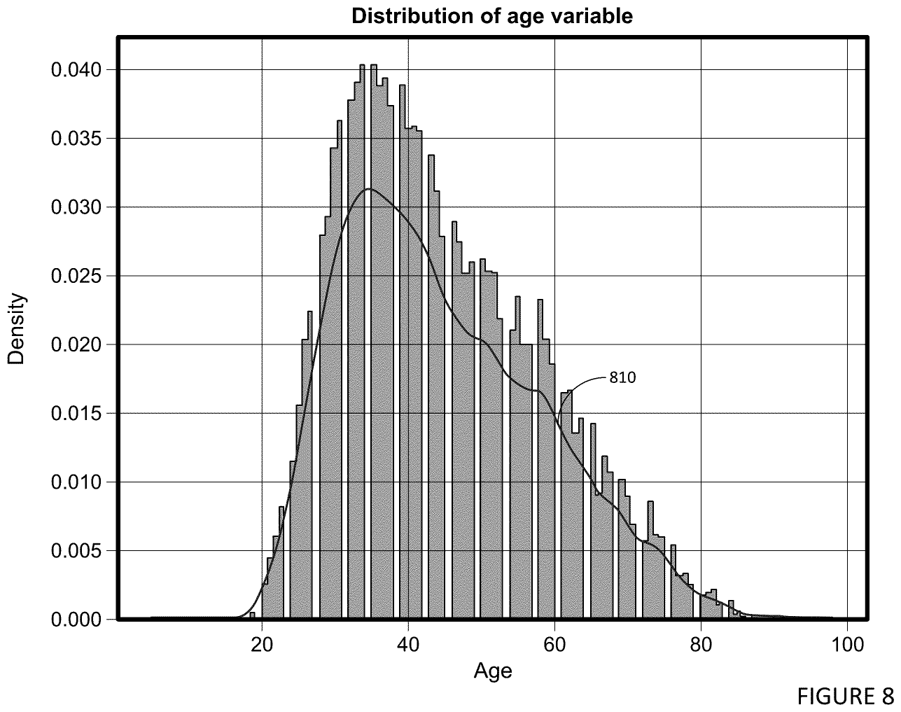

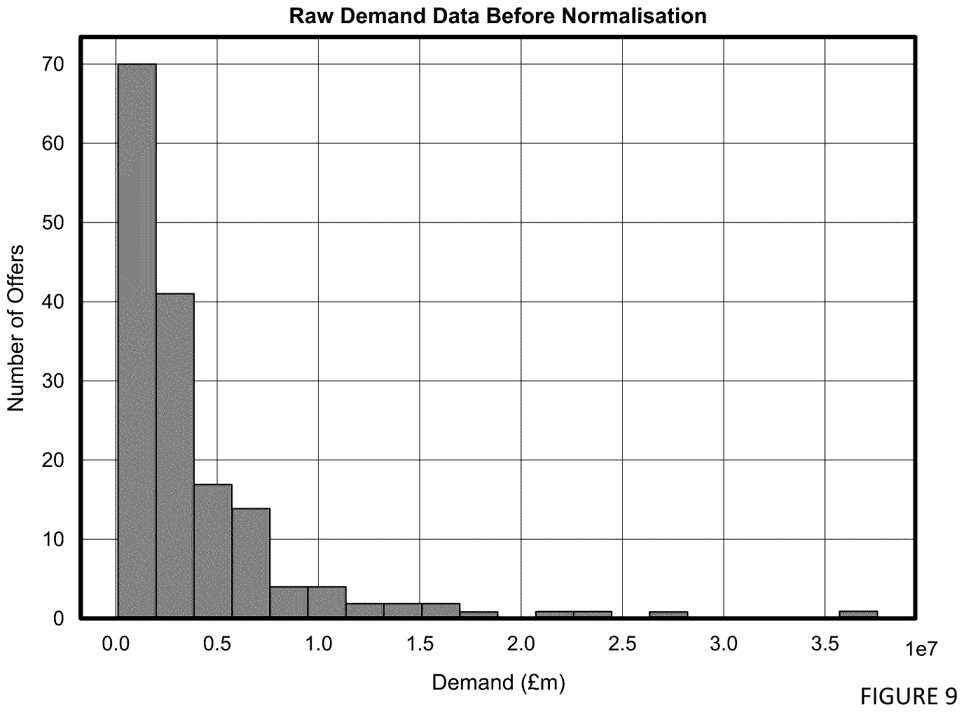

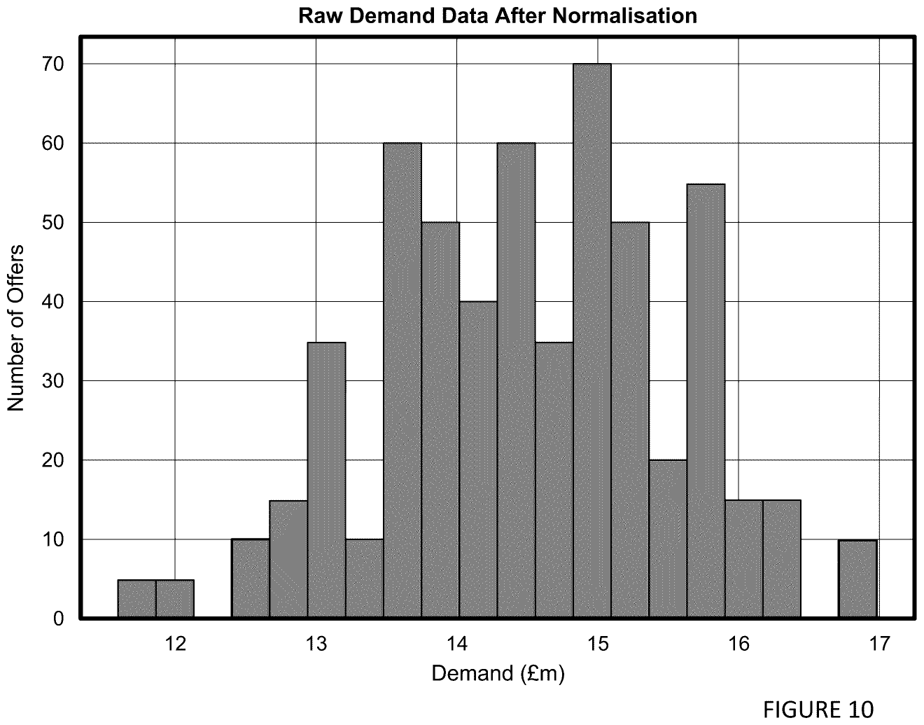

FIG. 8 depicts a distribution of user age from historical data for a closed deal. Curve 810 depicts how the distribution is skewed. FIG. 9 depicts a distribution of user age relative to demand from historical data for a closed deal. Using this information, the distribution of demand can be normalized. Data may be normalized via a log function as depicted in FIG. 10 or using various other normalization approaches. For instance, data may be normalized by dividing values by the population or sample mean, or by other methods such as harmonization.

In some instances, input features may be converted from numerical values to categorical features through bucketing, and these categorical features may be converted to numeric representation through one-hot encoding techniques. For example, referring to FIG. 3B, the buckets for age may be converted to discrete numerical values (e.g., 1, 2, 3, etc.) representative of each of the buckets (e.g., unknown age, 18-30, 30-40, etc.) depicted in FIG. 3B. Similarly, referring to FIG. 3C, the buckets for postal area groupings may be converted to discrete numerical values representative of each of the buckets (e.g., Wales, South England, London, etc.) depicted in FIG. 3C.

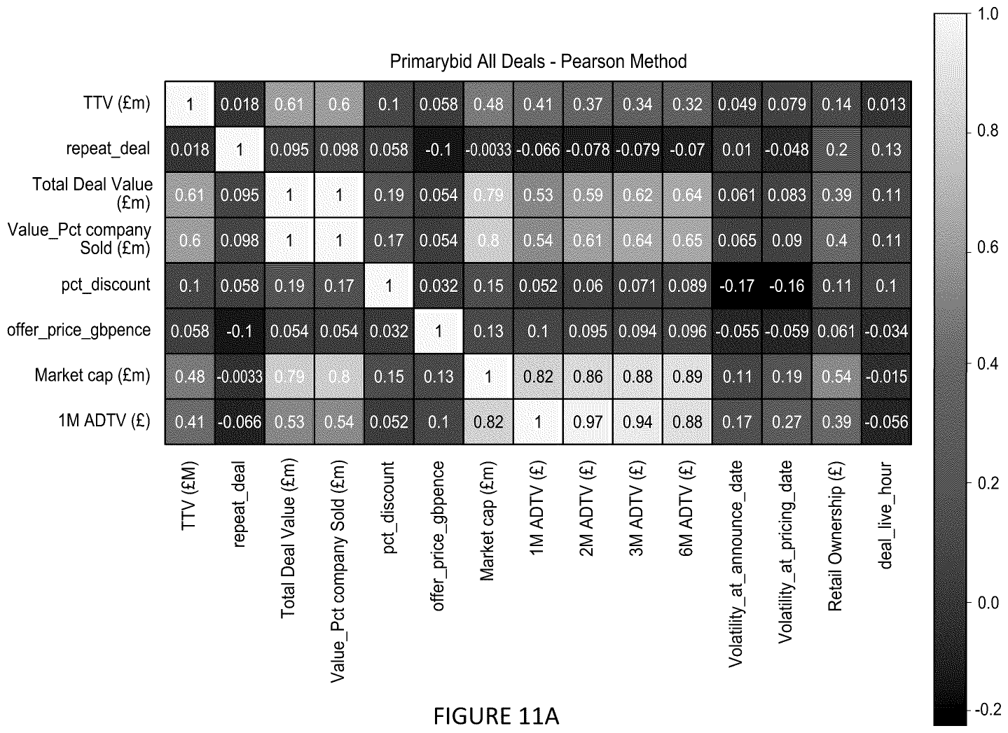

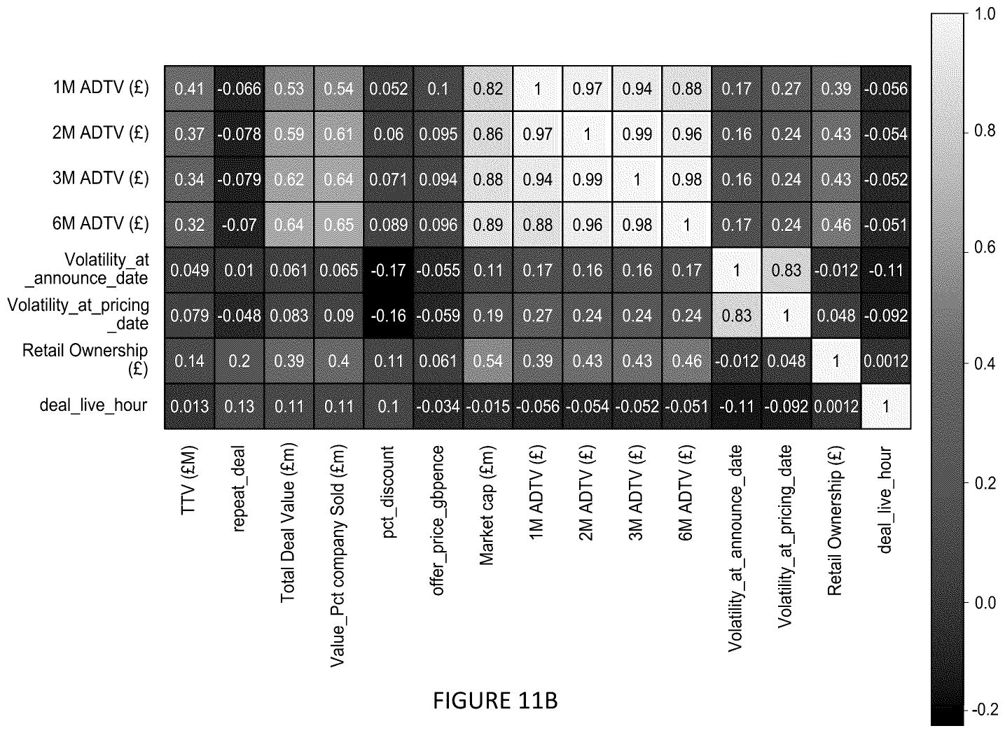

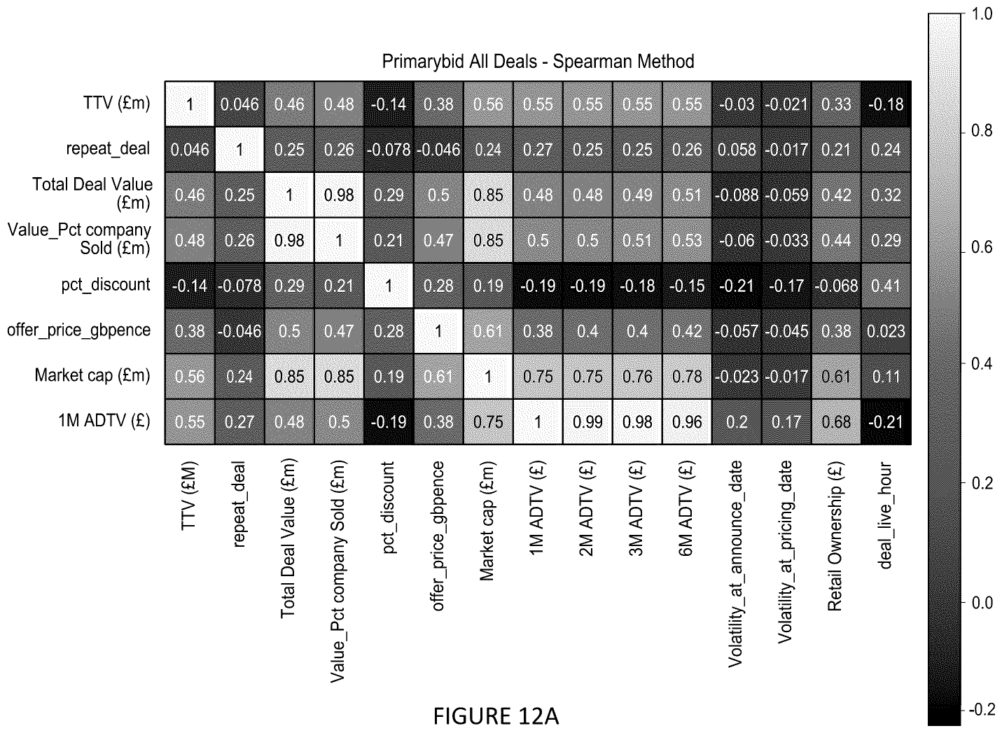

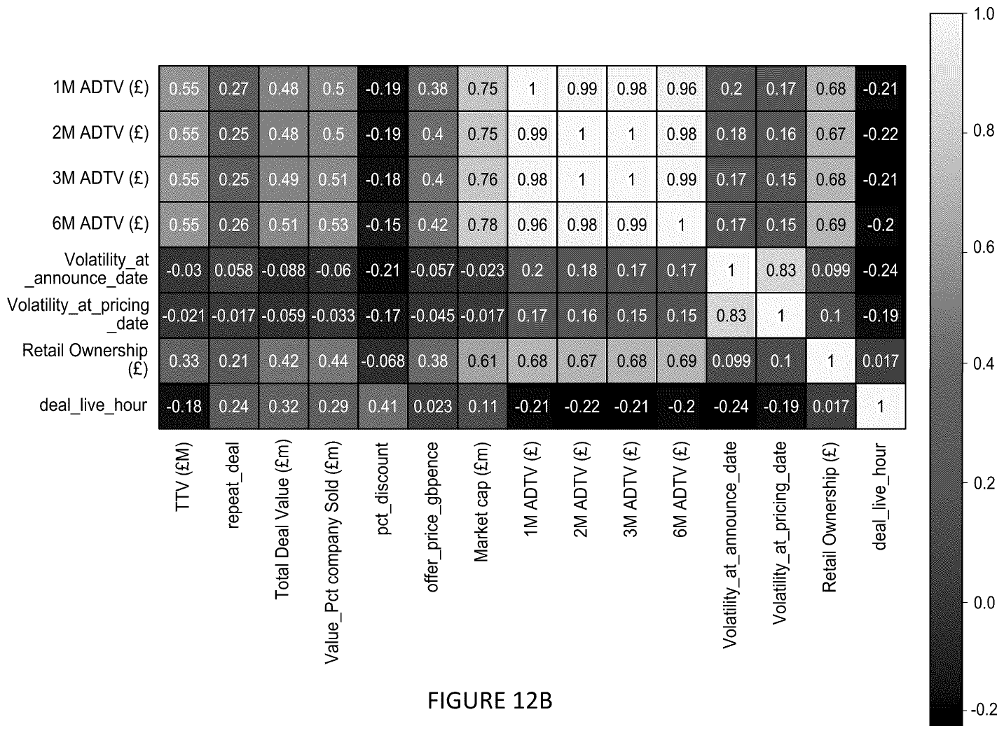

In some instances, which features to be used may be determined using a correlation matrix to identify the most relevant features for the pre-deal demand models and to reduce the number of input features to those that are most impactful. This may reduce the number of dimensions and complexity of the pre-deal demand models as well as the amount of preparation needed to input features for a new offering in the future. For instance various methods, such as the Pearson method or the Spearman method, may be used to understand the relationships between features and select highly relevant input features. The resulting correlation matrices may identify the correlation coefficients between two input features. FIGS. 11A-111B provide an example representation of a single correlation matrix for historical data for a closed deal using the Pearson method. As will be understood, the matrix is broken across FIGS. 11A and 11B. FIGS. 11A-11B provide an example representation of correlation matrices for historical data for a closed deal using the Spearman method. For instance, each correlation coefficient may have a value of between −1 and 1, where “0” means there is no relationship between the variables at all, and −1 or 1 means that there is a perfect negative or positive correlation. In this example, a negative or a positive correlation may refer to the type of graph the relationship will produce.

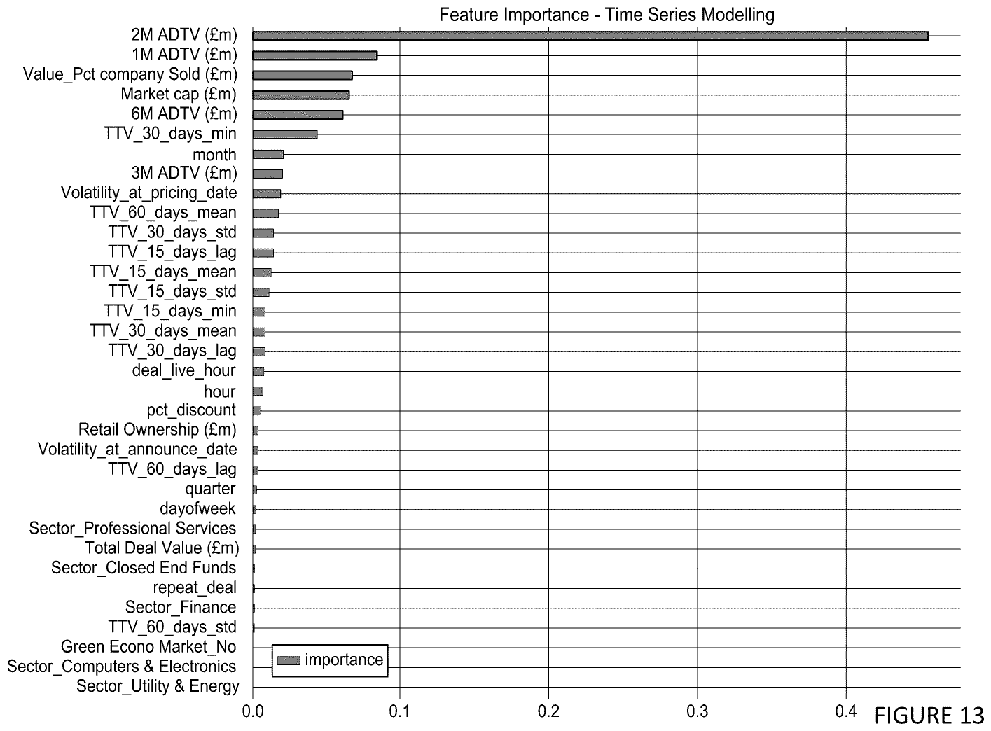

In this regard, the aforementioned input features and their respective contributions to the output features of the pre-deal demand models may be plotted in order to identify which input features are most relevant for training and use of the pre-deal demand models. FIG. 13 represents a graph of pairwise comparisons of feature importance (on a relative, normalized scale) relative to demand forecasting for historical data for a closed deal. The most important features are arranged towards the top of the graph and the least important features are arranged towards the bottom of the graph. The importance of each feature corresponds to the contribution or influence of that feature to the outcome of the demand prediction generated by the pre-deal demand prediction model. For example the average daily trading volume in the last 2 months (2M ADTV) may be the most influential for a time series predictive model. The month, the time of the launch (e.g., the exact time the in-deal phase starts, such as 1 μm or 5 pm, etc.), deal live hour, and sector (e.g., general, specific, etc.) may also provide more impactful contributions than other input features.

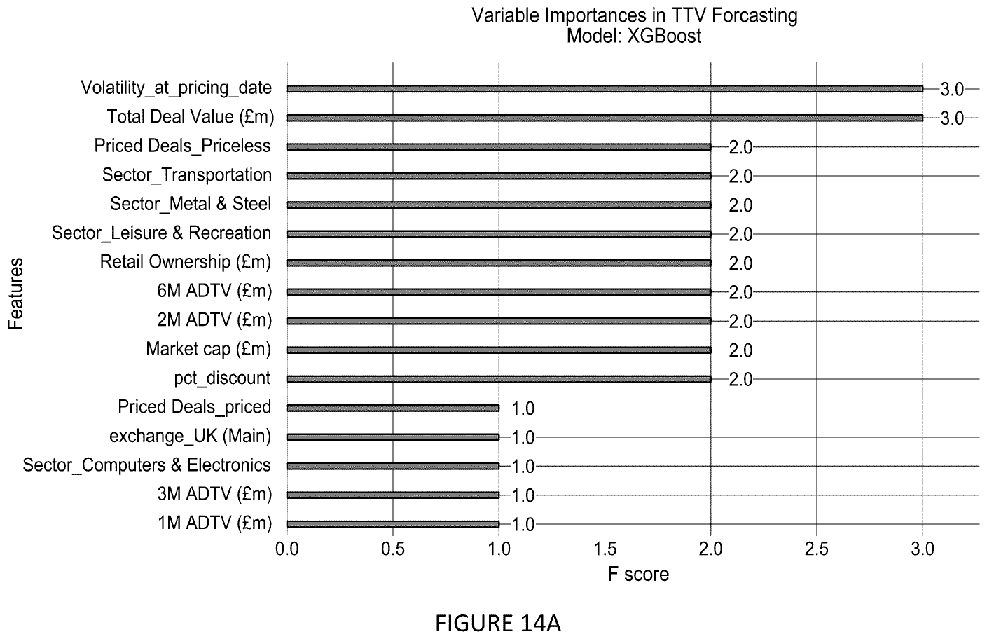

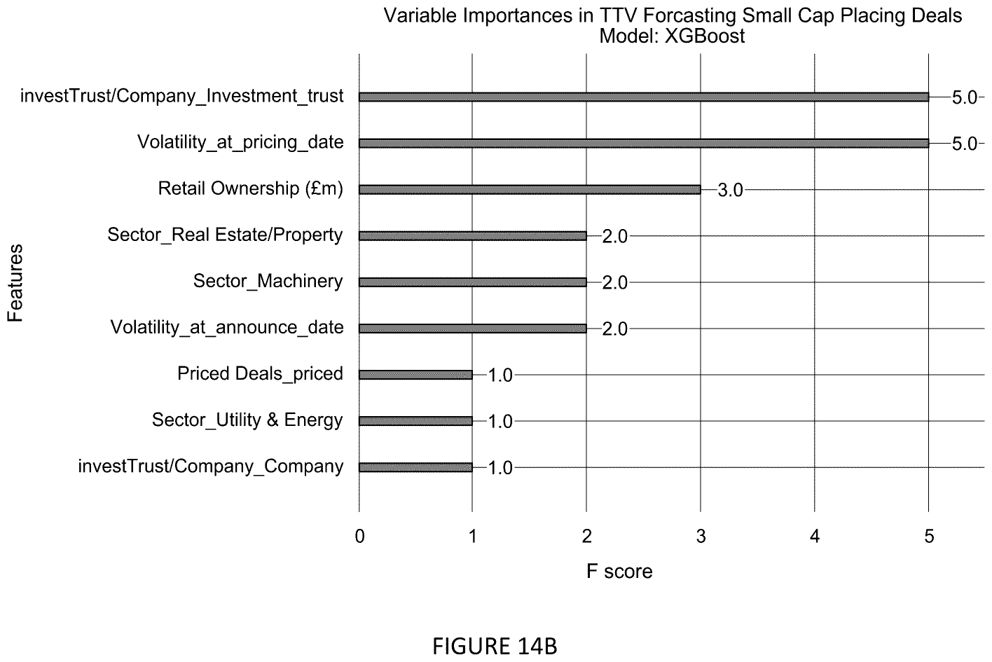

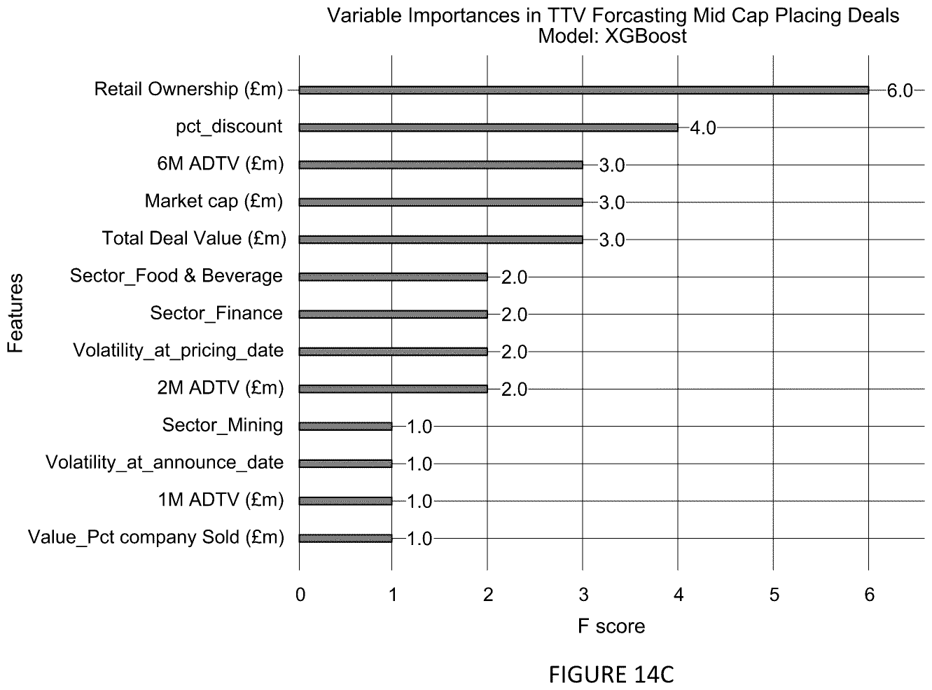

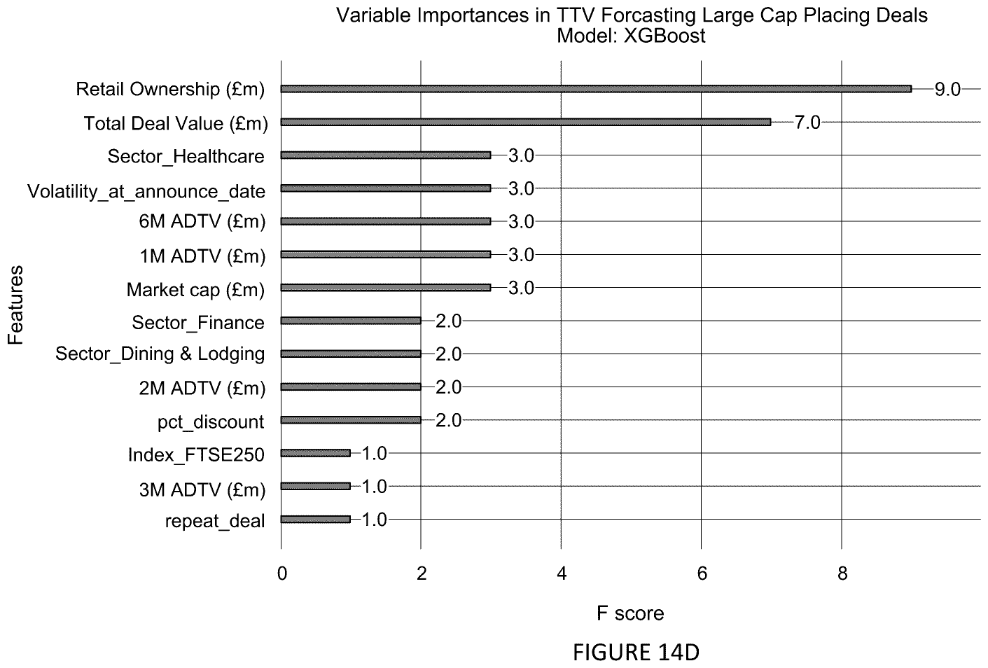

FIGS. 14A, 14B, 14C, and 14D each provide graphs of the most important features for different types of deals. FIG. 14A provides a representation of the most important features with respect to the XGBoost pre-deal demand models for microcap deals or deals having a market cap of less than 75 million pounds (£). As used herein, “TTV” represents total demand for a deal, and “F” represents a feature score corresponding to how many times in a model building and training processes for the models described herein that each attribute is used. As such, the features score may represent the relative importance of each attribute relative to other attributes used in the model training. FIG. 14B provides a representation of the most important features with respect to the XGBoost pre-deal demand models for small cap deals or deals having a market cap of between 75 million and 275 million pounds (£). FIG. 14C provides a representation of the most important features with respect to the XGBoost pre-deal demand models for midcap deals or deals having a market cap of between 275 million and 1 billion pounds (£). FIG. 14D provides a representation of the most important features with respect to the XGBoost pre-deal demand models for large cap deals or deals having a market cap of greater than 1 billion pounds (£).

Returning to FIG. 25, at block 2530, the plurality of training input features and the plurality of training output features are used to train a model configured to generate a prediction for a new offer based on a plurality of input features for the new offer. The pre-deal models may be trained by adjusting model parameter values (e.g., including hyperparameters) of the pre-deal models. These adjusted model parameter values may be stored with the pre-deal models, e.g., demand or allocation, in the storage system 160.

The pre-deal demand models may be configured such that for a given set of input features (e.g., proposed launch date, proposed launch time), a demand prediction may be generated including plurality of dynamic time-series values. These may include “lag” or “window” features, (for example, “Average Daily Trading Volume in the 30 days before the proposed launch date”). The length of these windows may be determined based on historical training data, with the “best” windows chosen being those that provide the most predictive power in the demand models. Examples of lag functions may include variables that represent market volatility and market sentiment. As noted above, deal-specific features for each offering may be paired with a plurality of the aforementioned input features for modeling purposes.

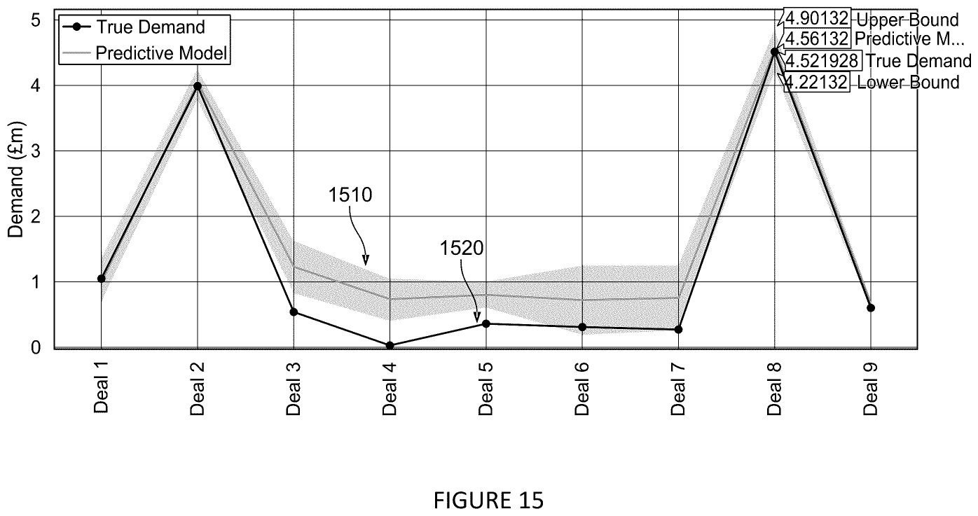

In this regard, the pre-deal demand models may be configured to provide a feature analysis corresponding to a prediction of demand. Each prediction may include a confidence interval which identifies lower and upper bounds for the prediction. FIG. 15 provides an example representation of demand predictions (predictive method line 1510) plotted with actual demand (true demand line 1520) from historical data for a plurality of deals (Deal 1, Deal 2, Deal 3, Deal 4, Deal 5, Deal 6, Deal 7, Deal 8 and Deal 9). The shaded area above and below the predictive method line 1510 represents the confidence interval for each of the plurality of deals.

The pre-deal demand models may also reveal insight into which inputs have the greatest effect on the predictions. With these predictions, an issuer may be able to simulate demand for an array of potential launch days and times, from which the models may even provide suggestions for the “best” timing (e.g., date and time for initiating the in-deal phase) to maximize demand.

In some instances, different input features may also be used to train the different pre-deal demand models for different purposes, and each of these pre-deal demand models (and corresponding parameter values) may also be stored in the storage system 160. For example, similar plots may be used to determine how micro, small, mid and large market cap IPOs may be affected differently by different input features. In this regard, the input features and the models themselves may be very different. In addition, the pre-deal demand models may be further broken out into direct investor (first party or 1p) pre-deal demand models, indirect investor (third party or 3p) pre-deal demand models, and broker pre-deal demand models. In this regard, for each combination of market cap size (e.g., micro, small, mid or large market cap) and investor/broker (e.g., 1p, 3p or broker), a different pre-deal demand model may be generated and trained.

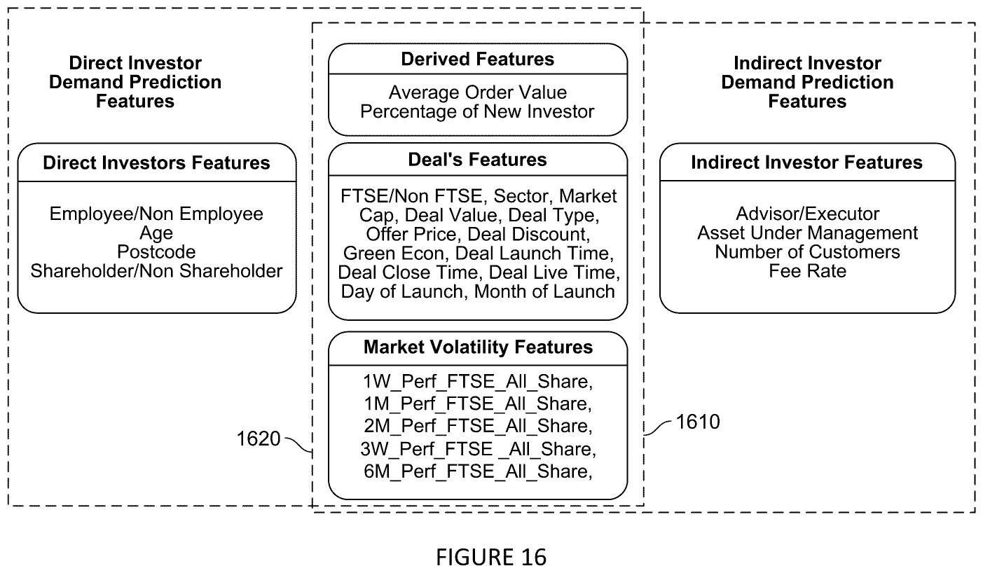

FIG. 16 provides an example feature set diagram for the 1p pre-deal demand models (those within the Direct Investor Demand Prediction Features boundary 1610) as well as features used in the 3p pre-deal demand models (those within the Indirect Investor Demand Prediction Features boundary 1620) for issuers traded on the FTSE. The feature set diagram provides a few examples of the features in each feature set. In this example, both the 1p pre-deal demand models and the 3p pre-deal demand models share 3 feature sets: Derived Features, Deal's Features and Market Volatility Features.

Each 1p pre-deal demand model may be an XGboost, Ridge regressor, Gradient Boosting Regressor and Quantile Random Forest model. In addition, each 1p pre-deal demand model may use a combination of dynamic and static features. The dynamic features may intend to capture the volatility of the market and market sentiments. This may thus include all the statistical time series features such as VIX @announc. date, VIX @pricing date, V2X @announc. date, and V2X @pricing date. The static features may capture features of an offering such as ‘Sector’ (e.g., general, specific, etc.) and also investor's attributes such as ‘Is the investor a shareholder or not’ and ‘Is the investor an employee or not’. The output features of the 1p pre-deal demand models may provide insight on the average amount that can be raised from each cohort (age, postal zip code, etc.) for each offering or deal type (placement, IPO, secondary, fixed income etc.).

Each 3p pre-deal demand model may be a combination of a tree-based algorithm and a regression model. The 3p pre-deal demand models may provide predictions for demand from the total indirect investor for each deal type. The historical data used to train the 3p pre-deal demand models may include three feature sets: attributes of the offering, 3p attributes, and derived statistical attributes.

The broker pre-deal demand models may be configured as a sub model of a 3p pre-deal demand model. The broker pre-deal demand models may be configured to forecast how much can be raised from each indirect partner (e.g., broker) for a given offering. The input features for this model may be the same or similar to the input features for 3p pre-deal demand models, though the output values may be smaller as each broker may be only a subset of all of the brokers.

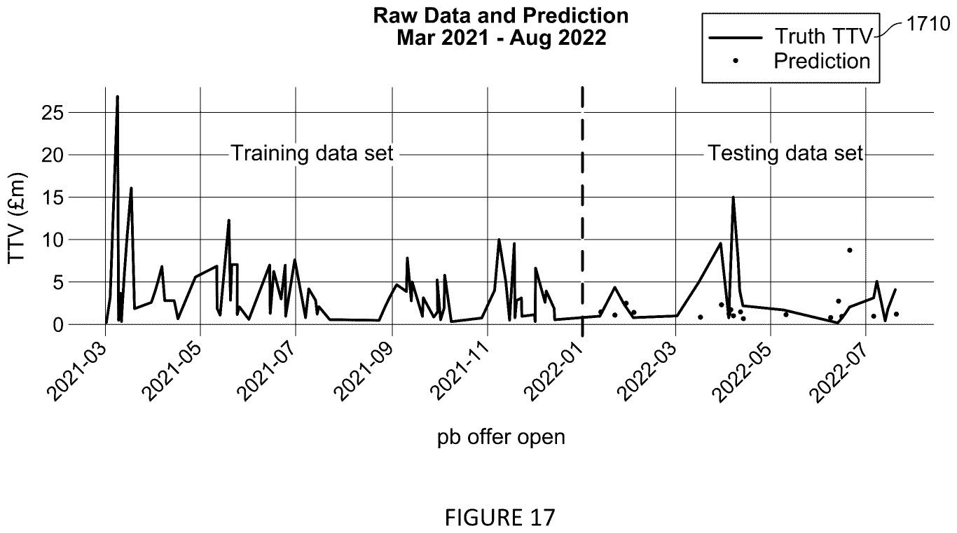

The pre-deal demand models may be tested using historical data for IPOs as inputs and comparing the outputs of the models to the historical data. FIG. 17 provides a comparison of historical data (raw data represented by Truth TTV line 1710) for a plurality of closed deals from different points in time to demand predictions (depicted as individual points) generated from the pre-deal demand models using the features of those closed deals. In this example, historical data for closed deals prior to January 2022 was used for training the pre-deal demand models, and historical data after January 2022, was used to generate the representative predictions.

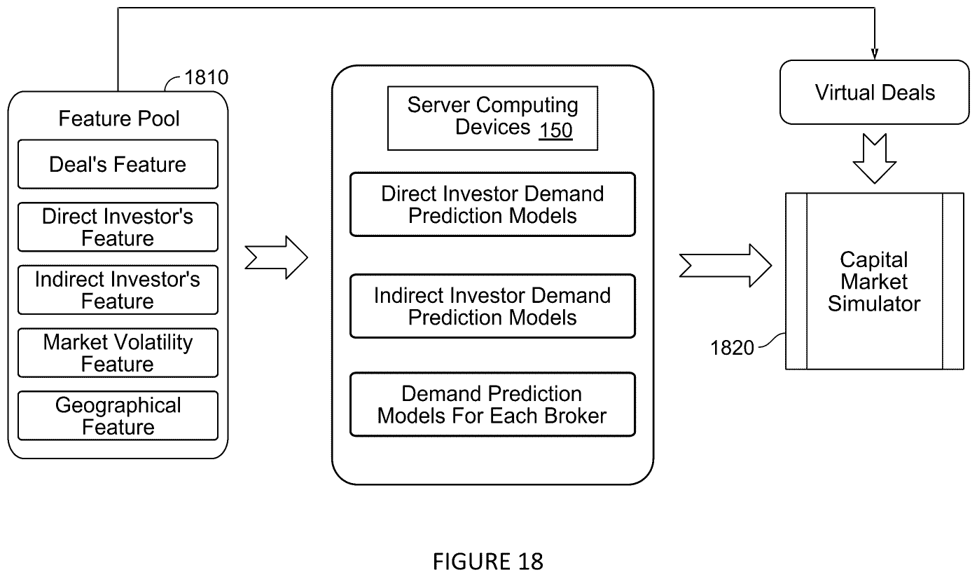

In some instances, the pre-deal demand models may be used to predict the outcome of the demand for different types of offers (e.g., fictitious, hypothetical, experimental, etc. offers) in different jurisdictions (e.g., different states, countries, etc.). FIG. 18 is an example functional representation of a prediction process. For instance, combinations of the input features 1810 (e.g., deal features, direct investor features, indirect investor features, market volatility features, geographical features, etc.) may be generated for an offer and input into each of the pre-deal demand models (e.g., 1P, 3P, broker) by the server computing devices 150. The output of these models may then be input into a capital market simulator 1820 in order to determine expected demand for different jurisdictions. This may enable the system to predict demand, for instance in different countries. The output of the simulator may then be used as a guideline for locations where the system may be most useful for different types of offers.

An issuer may leverage the outputs of the pre-deal demand models for a wide variety of activities. For example, an issuer may leverage the demand models to simulate the launch of their deal at various days and times to choose the “best” time for the deal to begin. As another example, the issuer may expand or contract the set of eligible cohorts that can participate in a deal based on their forecasted demand. Additionally, the issuer may change the minimum or maximum ticket sizes to either increase or decrease expected demand. Furthermore, the issuer may work with stakeholders to reset expectations about the size of the deal, if predicted demand is much higher or lower than they had planned for, or to help set the discount or price point for the deal to affect the demand that it will generate.

An issuer may also leverage the outputs of the pre-deal demand model to engage with specific user cohorts before or during a deal. For instance, if the predicted demand for a particular user cohort is low, an issuer may choose to upweight marketing spend or volume of communications to that cohort. An issuer may also choose to leverage specific marketing channels or messages based on the recommendations made by the pre-deal demand model.

Pre-deal allocation models may be configured to provide a feature analysis for a given prediction of demand as noted above. In other words, with a predicted demand generated for a deal, an issuer may apply a range of allocation policies to simulate their impact across user cohorts. Such allocation policies may be rules-based and may be provided by the issuer and may be specific to the particular offering. An allocation policy may employ a series of custom user attributes. The allocation policies may be applied to the output of the pre-deal demand models. The allocation policies may be optimized for multiple constraints, expressed in a variety of mathematical formats. For example, an allocation policy such as “ensure eligible shareholders receive a minimum of $300 of the issuance” may be combined with a second allocation policy such as “do not scale-back any investor more than 50%”.

The following is an example pseudocode representation of an allocation policy related to employment status:

Allocation Policy 1 - based on employment status:

```
IF Total Demand > Total Available Allocation
AND Employee Demand < 75% of Demand
  THEN Employee Allocation % = 100%
AND Non-Employee Allocation % =
(Total Allocation Available − Employee Allocation) /
(Total Demand − Employee Demand)
IF Total Demand > Total Available Allocation
AND Employee Demand > 75% of Demand
  THEN Allocation % = (Total Available Allocation) /
  (Total Demand)
IF Total Demand < Total Available Allocation
  THEN Allocation % = 100%
```

The following is an example pseudocode representation of an allocation policy related to issue attribute:

Allocation Policy 2 - based on issuer attribute:

```
IF Total Demand > Total Available Allocation
AND Customer Spend with Issuer in Last 12 Months > 100,000
  THEN Allocation % = MIN(100%, (Customer Spend
  with Issuer in Last 12
Months / 10K)% + 2% * (Years Tenure), 80%)
  ELSE Allocation % = Remaining Allocation /
  Remaining Demand
IF Total Demand < Total Available Allocation
  THEN Allocation % = 100%
```

Each allocation policy along with a final demand prediction may then be input into a pre-deal allocation prediction model in order to provide an allocation prediction expressed with summary analytics and which can be queried on a line-by-line basis. In other words, a final demand prediction may be input into the pre-deal allocation model in order to generate an allocation prediction for an allocation policy or a plurality of allocation policies (iteratively or at once).

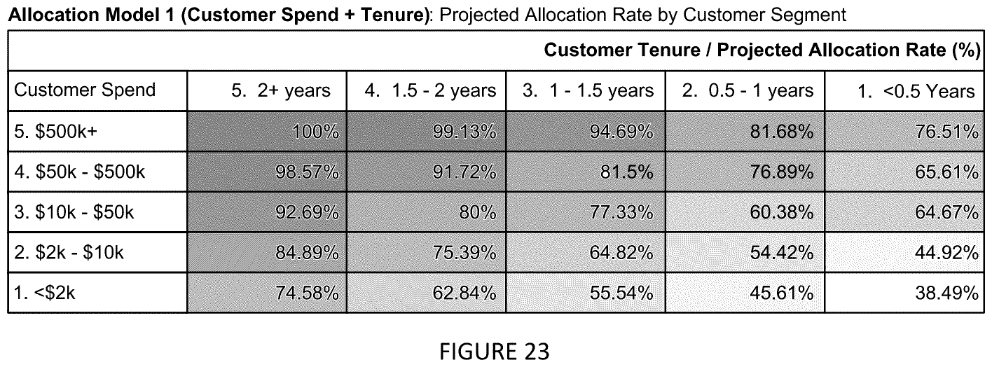

For example, the output of the pre-deal allocation models (e.g., allocation predictions) may be arranged, for example, in a table enabling the issuer to view and quickly understand potential impacts of a given allocation policy on participating users, for example as depicted in FIG. 23 below with respect to allocation predictions for the in-deal phase. In addition, multiple allocation policies can be “tested” and compared by the issuer simultaneously, even before a deal opens.

The pre-deal allocation models may also be used to provide recommendations to the issuers as to the “fairest” or “best” allocation policies that they could apply. These may be based on analysis of historic allocation policies from previous deals and their outcome, and also may include input from the issuer before the deal as to what their goals are for allocating the book.

In some instances, the system may also automatically provide notifications and recommendations based on the allocation predictions. For instance, the system may track certain legal or business requirements, such as minimum ownership by certain cohorts of users (e.g., citizens of a particular jurisdiction or users who are also employees), and send notifications or recommendations for adjusting allocation policies if allocations are at or near certain threshold values. For example such notifications may indicate that “Allocation policy A is leading to an under allocation of users in cohort B”. In some instances, the system may also run analytics or iteratively adjust allocation policies to determine how changes to an allocation policy can better utilize certain cohorts. In such an example, the notification may indicate that “Allocation policy A is leading to an under allocation of users in cohort B. However Allocation policy C may result in better allocation to users of cohort B”. The issuer may then be prompted to adjust Allocation policy A or replace Allocation policy A with Allocation policy C. As another example, a notification may indicate that “Allocation policy A is not getting your desired engagement from cohort B because the minimum investment for that group is too high”. For instance, this may be surmised from the fact that in cohort B, no users are applying for anything but a minimum. The notification may also recommend decreasing the minimum investment for cohort B by some percentage or value for better results.

As noted above, each pre-deal allocation prediction model may include a machine learning model, such as a decision tree including random forest, which includes both numerical and categorical attributes of the issuer and users. Examples of such attributes may include sector (e.g., general, specific, etc.) of the issuer, whether the user is an existing shareholder, whether the user is an employee of the issuer, whether the offer is 1P or 3P, source (e.g. community or not community IPO, and may even be broken down over time into greater granularity between engaged community and passive community, etc.), first time user, offering type (placement, IPO, secondary, fixed income etc.), offering start day, offering end day, first subscription day, last subscription day (e.g., the last day that users can subscribe), and age (or age group).

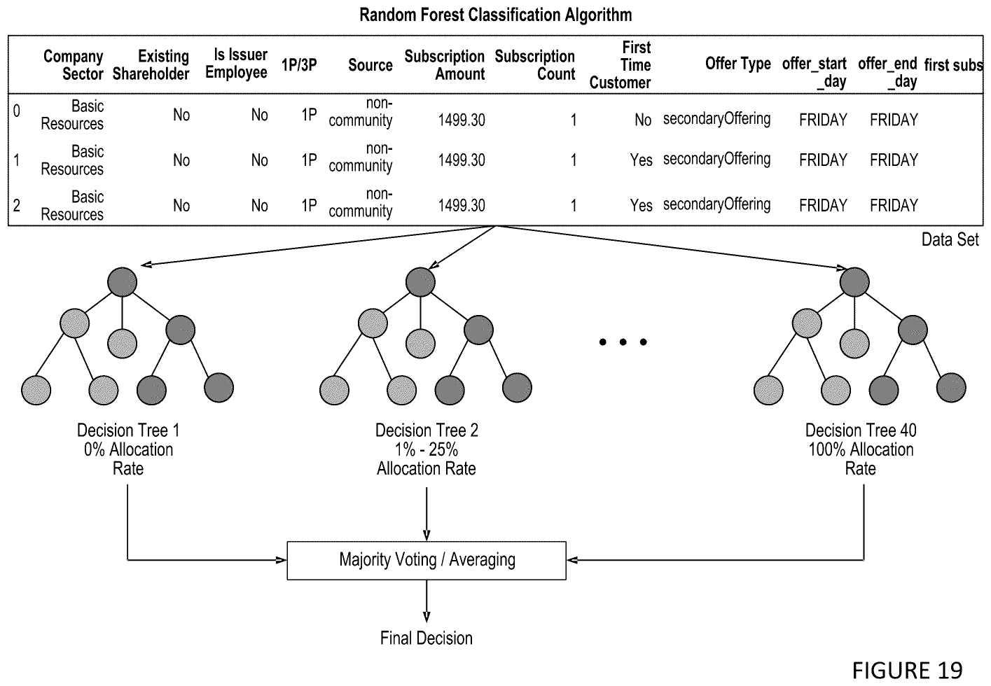

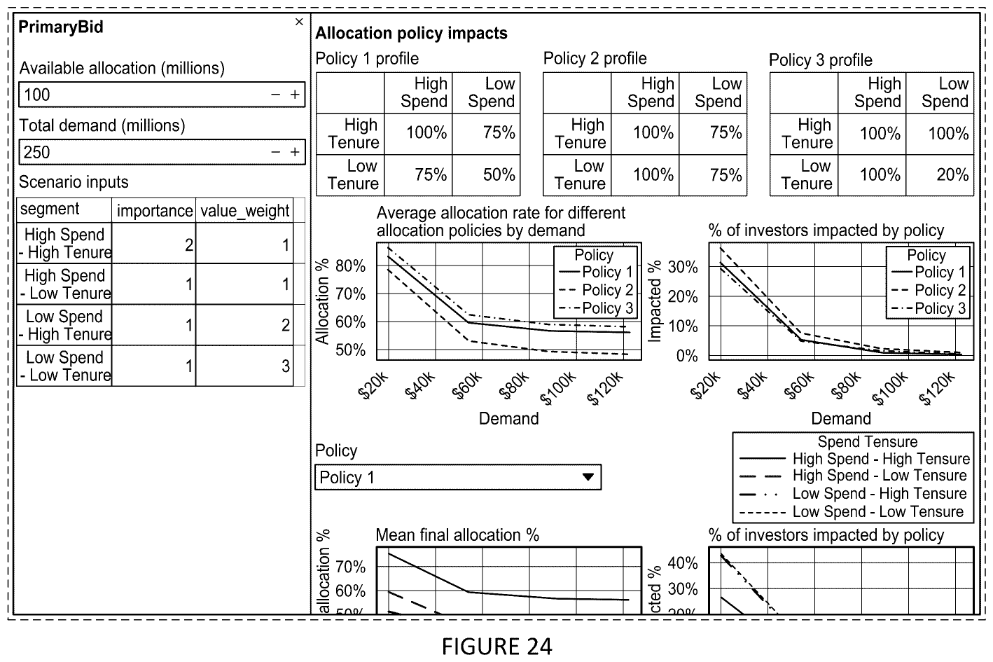

FIG. 19 is an example functional representation of an allocation prediction Again, the allocation prediction model may be trained using the aforementioned historical data. Examples of training inputs may include features such as (referring to the features of Table 1 above) “sector_general”, “Existing Shareholder”, “Is issuer employee”, “1P/3P”, “Source”, “first time user”, “Offer Type”, “offer_start_day”, “offer_end_day”, “first_subscription_day” “last_subscription_day”, and “Age” (here, specific age or age group). As depicted in FIG. 3A, the training output of the user allocation prediction models may be a plurality of buckets or ranges of allocation predictions (e.g., 0%, 1-25%, 26-50%, 51-75%, 76-99% and 100% allocation). Once the allocation predictions are provided to the issuer, as depicted in the example of FIGS. 23 and 24 discussed below with respect to allocation predictions for the in-deal phase, the issuer may use whatever process (e.g., majority voting or averaging) to select a final decision on which allocation policy to use.

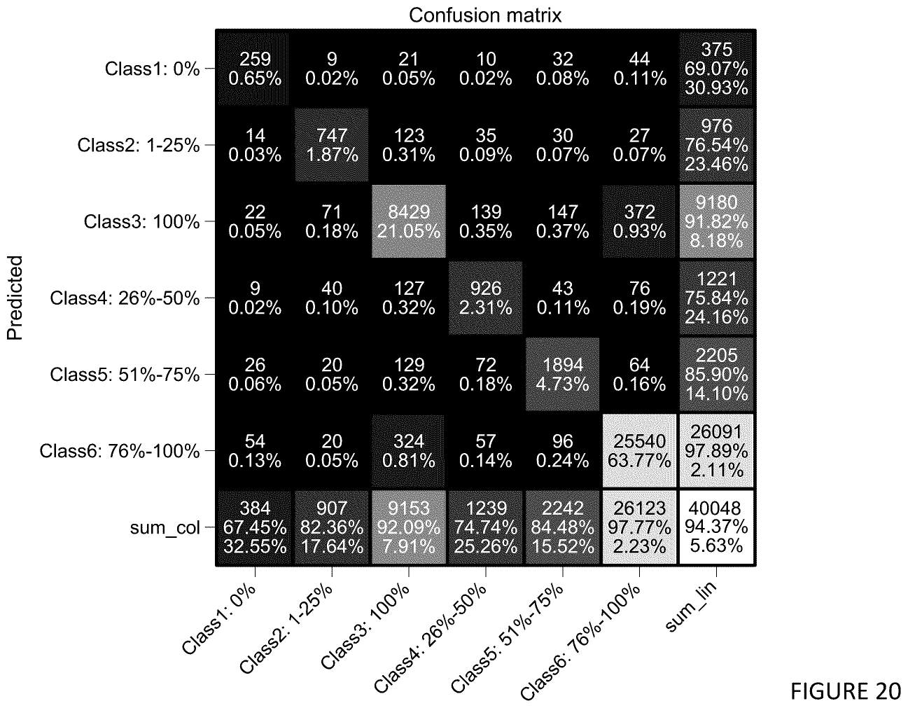

A confusion matrix may be used to demonstrate the performance of the pre-deal allocation models on testing data points (e.g., examples pulled or otherwise generated from the historical data). FIG. 20 is an example confusion matrix which demonstrates performance of an allocation prediction model on testing data points generated from historical data for closed deals. In this example, the pre-deal allocation model predicted the actual allocations with 94.37% accuracy. In addition, each class may represent a percentage of the allocation amount. For example, “Class 1-25%” may refer to all the cases where users are allocated between 1 and 25% of the user's subscription (e.g., requested value or amount of securities). In some instances, this could even be used to generate and display recommendations to users in real time to encourage greater subscription (e.g., participation) based on the intent of the issuer.

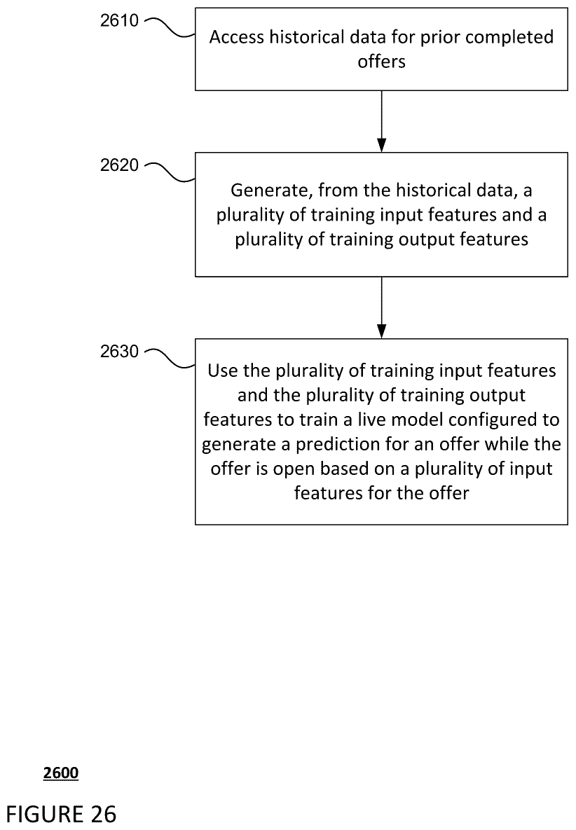

FIG. 26 is an example flow diagram 2600 for training a live model. This live model may include a live demand model or a live allocation model. At block 2610, historical data for prior completed offers is accessed. At block 2620, a plurality of training input features and a plurality of training output features are generated from the historical data. At block 2630, the plurality of training input features and the plurality of training output features are used to train a live model configured to generate a prediction for an offer while the offer is open based on a plurality of input features for the offer. The live demand and allocation models may be trained by adjusting model parameter (e.g., including hyperparameters) values of the live demand and allocation models. In addition, during the in-deal phase the parameters of the live demand and allocation models may be adjusted as the deal progresses, incorporating new information from the live deal demand in the first 30 minutes, demand in the first day, and so on. These adjusted model parameter and hyperparameter values may be stored with the live demand model in the storage system 160.

As with the pre-deal models, the live demand and allocation models may be trained using the aforementioned historical data using cohort and user attribute features as training inputs as well as actual final demand as training outputs. The cohort and user attribute features may include, for example, demographic information (e.g. age, location, etc.), information about their relationship with the issuer (e.g. the number of years they've had an open account with the issuer), as well as dynamic demand-based information (e.g. the total demand in the first 4 hours, or the change in demand between day 1 and 2).

The training outputs for the live demand model may take the form of a predicted demand number, with a confidence interval. This confidence interval may narrow as the deal progresses and the live demand model is better able to predict the shape of the final book. Additionally, the output may present the expected closing (e.g., when the in-deal phase closes) distribution of demand across user attributes (e.g. the share of demand from employees vs. customers).

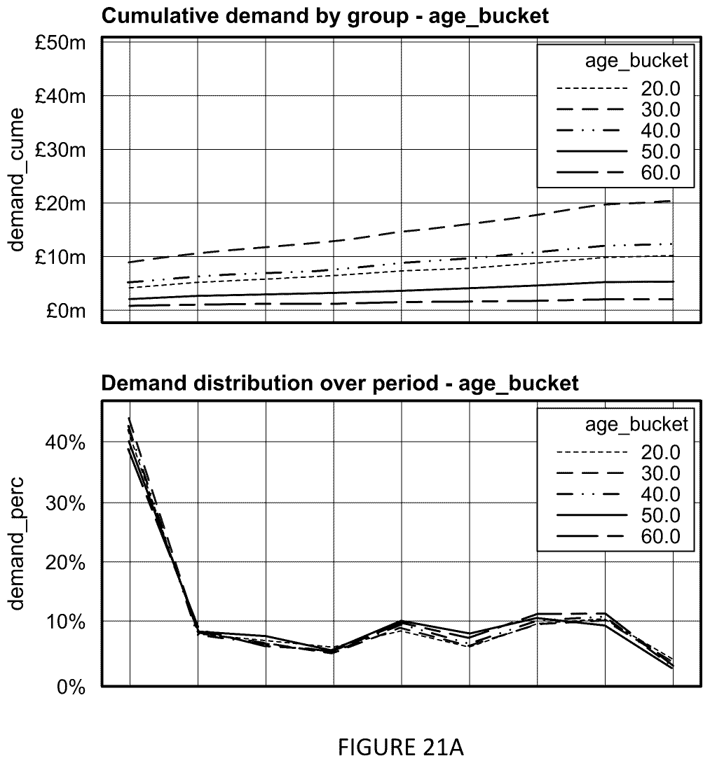

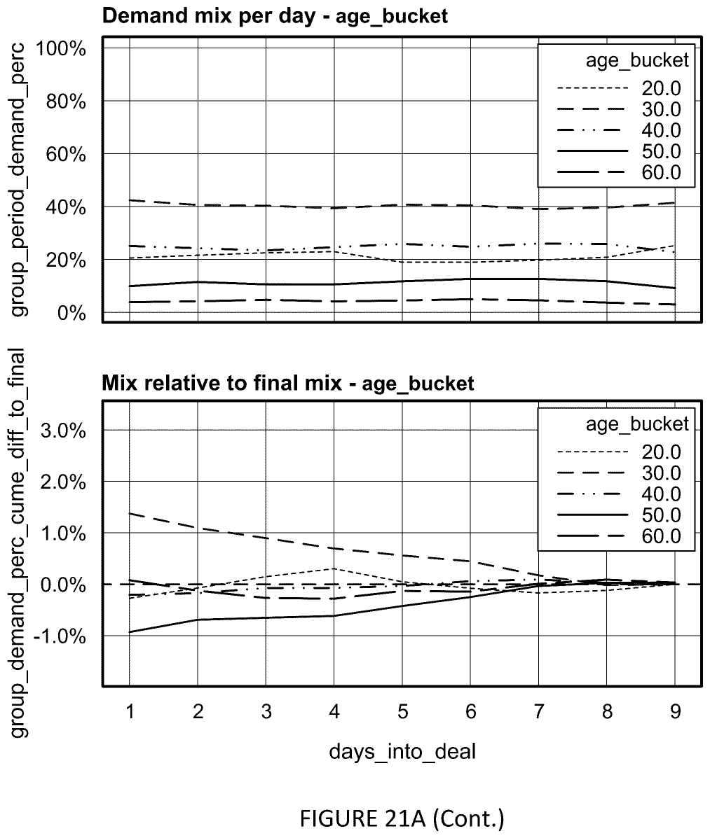

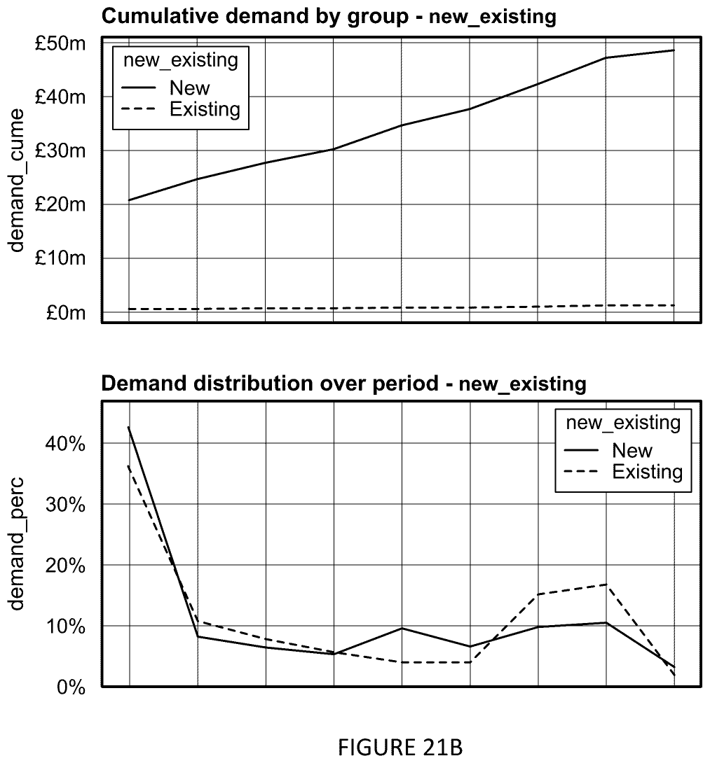

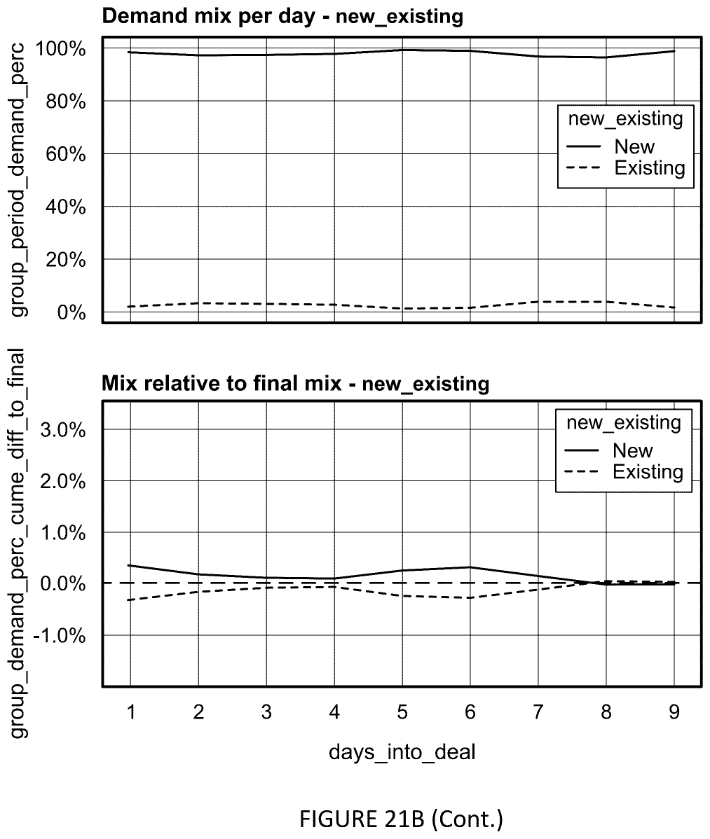

In addition, the live demand and allocation models may be trained on historical data. Example historical data which may be used as training inputs may include a range of IPOs or different types of offerings, broken down by user attributes. For example, FIGS. 21A and 21B provide example book build curves from historical data for closed deals for user attributes including user age in FIG. 21A (by bucket) and new or existing users in FIG. 21B. These may be used as training inputs for the live demand and allocation models.

In some instances, where the offer is not an IPO or other initial offering, historical data for this issuer may be used to train the live demand and allocation models. Of course for a new IPO, there will be no historical data for the issuer, so common attributes across IPOs may be used as a proxy for how demand will build over the duration of an IPO. Examples of such attributes may include, for example, whether a user is an existing shareholder or not, whether a user is an issuer's employee or not, whether a user is a qualified investor or not, whether the user is listed on a chairman's list or within a directed share program, user demographics, the amount of time that the user has been a customer of the issuer, the total lifetime spend of the user on the issuer's products. Additionally, attributes may include proposed marketing activity, such as the number of emails that an issuer plans to send to advertise the deals, as well as the channels, messages, or cohorts targeted by these communications.

In this regard, the live demand models may provide an estimate of the percentage of demand expected from each cohort and/or individual user attributes. As such, the live demand models may also provide insights into correlations between user attributes, for example a model trained on IPOs may identify an attribute common across historic deals (e.g. age), is highly correlated with an issuers attribute (e.g. number of ‘points’ on their issuer account). Live demand models may identify these correlations as the deal progresses allowing them to be leveraged in the allocation predictions generated by the live allocation models.

During the in-deal phase, or when an offer is live, information related to the offer (e.g., fundraising, cohort participation rates, etc.) may be tracked by the system in real time. For instance, the system may track how many new brokerage accounts have been created as part of the process, fundraising status, cohort participation rates (e.g., broken out by demographics), etc. This real-time or live information may be used to predict demand during the deal by inputting the live information as well as other information (e.g., information which was used to generate a pre-deal demand prediction) into the live demand model. The live information as well as the predicted demand may also be provided to the issuer during the deal. For example, an issuer may log into a portal in order to review information about the status of an offer. Such information may be leveraged this data for in-deal, post-deal, and future marketing efforts as a basis for a user engagement with the issuer and/or the system.

As noted above, the pre-deal demand models may use many features from market data, deal's feature, 1p and 3p features. However, the pre-deal demand models would not utilize live information as the deal has not yet opened. The live demand models may use the behavior of demand flow from historical data (how much subscription in day1, day2, subscription from different age groups, etc.) in conjunction with live information about the deal generated in real time.

For issuers, in addition to providing real-time information about the status of a deal, the system may also forecast how a book will close. The live demand models may use the pre-deal prediction as a starting point, and then provide a refined estimate for closing demand as the book builds and as new information is available (e.g. demand in the first 4 hours of the deal, or rate of change of demand in day two vs. day one). In addition, once users have begun to submit demand, a live demand model may be used to forecast the closing distribution of demand across a range of user attributes (e.g. the amount of demand that will come from different cohorts of users once the deal closes). This may be achieved using a combination of live demand models and allocation prediction models.

As information for the offering (e.g., as new users participate or subscribe) is input into the system, it may be combined with user attribute and cohort information and input into the live demand models. As noted above, the live demand models may be linear regression models such as Ridge, Lasso and Elastic Net models which may have different penalties to a cost function, and can handle both numerical and categorical data types in their prediction. The live demand models may be used to provide predictions for how demand will look by cohort once the offer closes (e.g., “predicted final demand”). This may allow an issuer to evaluate the impact of various allocation policies on each cohort based on the predicted final demand. The live demand models and allocation prediction models may be updated in real-time, giving the issuer an opportunity to understand the implications of changes in live demand as they occur. In this regard, the live demand models may predict the final distribution of demand across a variety of user attributes and cohorts or the prediction of final demand.

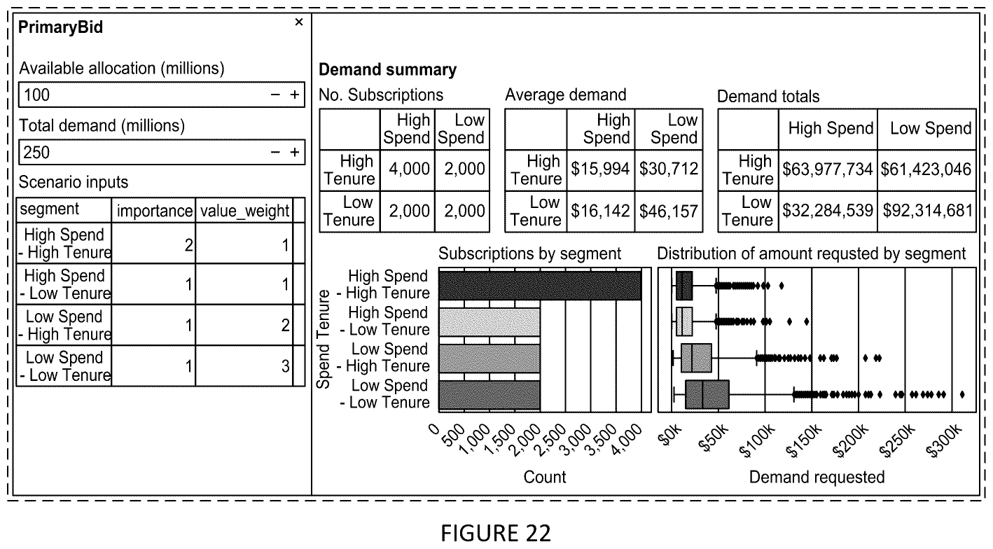

FIG. 22 provides an example visualization of demand prediction and related information for a live deal that may be displayed to a representative of an issuer (or an advisor of the issuer) on a display of a client computing device, such as client computing device 140 described above. In this example, the visualization provides information such as the predicted final number of subscriptions, average demand, and demand totals for users in different cohorts (e.g., high-spend/high-tenure, high-spend/low-tenure, low-spend/high-tenure, and low-spend/low-tenure). In this example, high and low are arbitrary values which may change depending upon the situation, and tenure may refer to how long the user has been a customer of the issuer and/or a user of the system. The visualization also provides charts which depict subscriptions by cohort (segment) as well as a prediction of demand in dollars for these cohorts.

Once again, with a final demand prediction generated for the final outcome of a deal, an issuer (or the representative or advisor of the issuer) may apply a range of allocation policies to simulate their impact across user cohorts. Again, as described above, such allocation policies may be rules-based and may be provided by the issuer and may be specific to the particular offering. In this regard, the final demand prediction may be input into the live allocation model in order to generate an allocation prediction for an individual allocation policy or a plurality of allocation policies (iteratively or at once).

The allocation predictions may be expressed with summary analytics and which can be queried on a line-by-line basis. For example, the output of the live allocation model may be arranged in a table enabling the issuer to view and quickly understand potential impacts of a given allocation policy on participating users. FIG. 23 is an example representation of an allocation prediction for a particular allocation policy for a plurality of different cohorts (broken out by spend and tenue combinations as in the example of FIG. 22) for a given final demand prediction. In this example, the example spend amounts are $500,000 or more, $50,000 up to $500,000, $10,000 up to $50,000, $2,000 up to $10,000, or less than $2000, and the tenure examples are 2 or more years, 1.5 up to 2 years, 1 up to 1.5 years, 0.5 up to 1 year, or less than 0.5 year. as well as a prediction of demand in dollars for these cohorts.

In addition, multiple allocation policies can be “tested” and compared by the issuer simultaneously, even before a deal closes. FIG. 24 is an example visualization of allocation predictions for a plurality of allocation policies, here Policy 1, Policy 2, Policy 3, for a final demand prediction for live deal that may be displayed to a representative of an issuer (or an advisor of the issuer) on a display of a client computing device, such as client computing device 140 described above.

Issuers may have different objectives about how to allocate securities. For example, an issuer may want to ensure that everyone gets at least $300, or may want to ensure that all of their existing shareholders receive 100% of each user's subscription. The visualization may flag the impact that these allocation policies are having on the total set of users who have submitted demand. For example, an allocation policy designed to provide 100% allocation to existing shareholders may be causing all non-shareholders to receive 0% allocation. By visually summarizing allocation policies and their effects, issuers may understand the impact that each policy has; issuers are then free to determine which allocation policies best meet the issuer's desired outcome for the allocation of securities.

The live allocation models may also be used to provide recommendations to the issuers as to the “fairest” or “best” allocation policies that they could apply. These may be based on analysis of historic allocation policies from previous deals and their outcome, and also may include input from the issuer before and during the deal as to what their goals are for allocating the book.

In some instances, the system may also automatically provide notifications and recommendations based on the allocation predictions. For instance, the system may track certain legal or business requirements, such as minimum ownership by certain cohorts of users (e.g., citizens of a particular jurisdiction or users who are also employees), and send notifications or recommendations for adjusting allocation policies if allocations are at or near certain threshold values. For example such notifications may indicate that “Allocation policy A is leading to an under allocation of users in cohort B”. In some instances, the system may also run analytics or iteratively adjust allocation policies to determine how changes to an allocation policy can better utilize certain cohorts. In such an example, the notification may indicate that “Allocation policy A is leading to an under allocation of users in cohort B. However Allocation policy C may result in better allocation to users of cohort B”. The issuer may then be prompted to adjust Allocation policy A or replace Allocation policy A with Allocation policy C. As another example, a notification may indicate that “Allocation policy A is not getting your desired engagement from cohort B because the minimum investment for that group is too high”. For instance, this may be surmised from the fact that in cohort B, no users are applying for anything but a minimum. The notification may also recommend decreasing the minimum investment for cohort B by some percentage or value for better results.

As with the pre-deal allocation models, each live allocation model may include a machine learning model, such as a decision tree including random forest, which includes both numerical and categorical attributes of the issuer and users. Examples of such attributes may include sector (e.g., general, specific, etc.) of the issuer, whether the user is an existing shareholder, whether the user is an employee of the issuer, whether the offer is 1P or 3P, source (e.g. community or not community IPO, and may even be broken down over time into greater granularity between engaged community and passive community, etc.), first time user, offering type (placement, IPO, secondary, fixed income etc.), offering start day, offering end day, first subscription day, last subscription day (e.g., the last day that users can subscribe), and age (or age group). However, in addition to such attributes used by the pre-deal allocation models, each live allocation model may also use inputs which are only generated during the in-deal phase such as the demand generated within the first 30 minutes or more or less of the in-deal phase, or such as the age mix of the first 1,000 investors in the deal, or such as the rate of change in demand between the first and second hour, or such as the percentage of investors in a deal who sign up for in-deal notifications. In this regard, a live allocation model may be trained using data which is not available or practical for use with the pre-deal allocation models.

As with the pre-deal allocation models, a confusion matrix may be used to demonstrate the performance of the live allocation models on testing data points (e.g., examples pulled or otherwise generated from the historical data). In some instances, this could even be used to generate and display recommendations to users in real time to encourage greater subscription (e.g., participation) based on the intent of the issuer.

In addition to modeling allocation policies for issuers, the system may also be used to provide similar information to users in real time. For instance, individualized user allocation prediction models may be used to provide an expected allocation rate that each user may expect to receive prior to the deal closing. In this regard, a user allocation prediction model may be used to generate a predicted allocation for an individual user. This may provide a given user with a realistic expectation of what they might be allocated during a deal, so that the given user does not overestimate or underestimate the allocation the user might receive. In some instances, these user allocation prediction models may even be used for targeted marketing to users who are identified as having undersubscribed given those users' allocation predictions. In addition, the output of the live allocation models may provide recommendations on the optimal timing throughout the deal to send notifications to help users maximize their allocation; for example, if a deal is near to close, and the user falls within a cohort that is under-allocated, a notification may be sent to suggest they may be eligible for a greater allocation.

Once the offer has closed, in the post-deal phase, an issuer may review the actual impact of different allocation policies against the final demand or outcome of the (now the closed book). For instance, various allocation policies may be applied to the final demand or final outcome of the deal. In some examples, when displaying the impact of different allocation policies, these may be ranked based on different goals or policies of the issuer and displayed accordingly. These rankings may be determined based on the objectives of the issuer; for example, if an issuer's objective is to provide a high % allocation to existing shareholders, then allocation policies may be ranked by the average allocation % to existing shareholders. Multiple rankings may be provided to the issuer if they have multiple objectives. The issuer may either specify its own allocation policy or choose an allocation policy recommended by the model. Once the issuer has decided on a policy, the system may automatically implement that policy.

Once the issuer has decided on a policy, the system may automatically implement that policy. As such, the features described herein may enable issuers to identify the most desirable allocation policy and automatically implement it. For example, when viewing the output of the allocation prediction model, an issuer may be able to select or approve certain allocation policies on an aggregate or line-by-line basis. A corresponding notification may be sent back to the system. In response, the system may trigger a series of actions, for example, generating a final list of allocations at a line-by-line level, communicating this allocation in detail and in aggregate to the issuer, their advisors, brokers, and other partners, emailing users confirmation of their final allocation, and triggering the settlement of users' securities via integration with custodians and/or users individual trading accounts, or by other means. In some instances, once the allocation is completed, the issuer may be provided with an exact line-by-line breakdown including the “account id” of each user and each user's actual allocation (e.g., the application percentage and allocation amount or number of securities) for each investor in the book. In some instances, this data is provided on an ongoing basis via API connections with the brokers. This enables them to communicate with those investors or even tag them within their own systems if they choose to provide them with, for example, shareholder perks or additional communications.

The features described herein may provide for demand and allocation prediction modeling for the processes of initial public offerings (IPOs), placements (e.g., private offerings, new public share issuances, etc.), secondary offerings, fixed income products (e.g., bonds), etc. Pre-deal demand modeling can be used to recommend which cohorts of users to include in the offering and to reduce the risk of over-subscription where more applications are received from users than the total number of securities offered, and may also be used to optimize the timing of the deal and the marketing and communication strategy before and during the deal window. In the in-deal phase, the issuer may be provided with a real-time analysis of live demand by cohort, demographics, and other information. This may enable issuers to develop relationships with new users as the issuer will have more relevant information about such users including past relationships with the issuer. As noted above, allocation policies may be applied to live demand predictions in the form of allocation prediction models. This may help issuers to mitigate the risk of rushing an allocation policy after a deal closes as in typical deals, and instead gives the issuer a preview during the pre-deal and in-deal phases of a deal of the impact of different allocation policies, thereby allowing the issuer to identify preferred, fair and balanced allocation policies before the offer closes.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising one or more server computing devices having one or more processors configured to:
access historical data for prior completed offers;
generate, from the historical data, a plurality of training input features and a plurality of training output features; and
use the plurality of training input features and the plurality of training output features to train a pre-deal demand model configured to generate a demand prediction for a new offer based on a plurality of input features for the new offer.

2. The system of claim 1, wherein the one or more processors are further configured to identify categories of the input features using a grid search algorithm.

3. The system of claim 1, wherein the one or more processors are further configured to identify categories of the input features using a correlation matrix.

4. The system of claim 1, wherein the input features include offering features, direct investor features and indirect investor features.

5. The system of claim 1, wherein the one or more processors are further configured to train a plurality of pre-deal demand models for different categorizations of market cap values.

6. The system of claim 1, wherein the one or more processors are further configured to train a plurality of pre-deal demand models for different types of offers including initial public offerings and offers that are not initial public offerings.

7. The system of claim 1, wherein the one or more processors are further configured to input the plurality of input features into the pre-deal demand model and generate the demand prediction.

8. The system of claim 7, wherein the one or more processors are further configured to select the pre-deal demand model from a plurality of pre-deal demand models based on one or more characteristics of the new offer.

9. The system of claim 1, wherein the one or more processors are further configured to, input the demand prediction into a pre-deal allocation model to generate an allocation prediction.

10. The system of claim 9, wherein the allocation prediction identifies how securities are expected to be distributed across cohorts of users with certain user attributes.

11. A system comprising one or more server computing devices having one or more processors configured to:
access historical data for prior completed offers;
generate, from the historical data, a plurality of training input features and a plurality of training output features based on the historical data; and
use the plurality of training input features and the plurality of training output features to train a live demand model configured to generate a demand prediction for an offer while the offer is open based on a plurality of input features for the offer.

12. The system of claim 11, wherein the one or more processors are further configured to track information related to the offer in real time and to input the tracked information into the live demand model and generate the demand prediction in real time while the offer is open.

13. The system of claim 11, wherein the tracked information includes participation rates of cohorts of users with certain user attributes.

14. The system of claim 11, wherein the one or more processors are further configured to input the demand prediction into a live allocation model in order to generate an allocation prediction for a plurality of potential allocation policies in real time while the offer is open.

15. The system of claim 14, wherein each allocation prediction identifies how securities may be distributed across cohorts of users with certain user attributes.

16. The system of claim 14, wherein each allocation policy is a rule-based policy that includes one or more user attributes.

17. The system of claim 14, wherein the live allocation model includes a decision tree.

18. The system of claim 11, wherein the demand prediction includes a prediction for demand for each of a plurality of different cohorts of users with certain user attributes.

19. The system of claim 11, wherein the plurality of input features is broken out by cohorts of users with certain user attributes, and the plurality of training output features are broken out by the cohorts of users with certain attributes.

20. The system of claim 11, wherein the one or more processors are further configured to, once the offer is closed, input a final demand for the offer into an allocation model in order to generate allocation predictions for a plurality of potential allocation policies.

21. The system of claim 20, wherein the one or more processors are further configured to receive user input identifying one of the plurality of potential allocation policies, and in response to receiving the user input, to automatically allocate securities.
